(19) United States
(12) Patent Application Publication
(10) Pub. No.: US 2026/0132518 A1
(43) Pub. Date: May 14, 2026

(54) ELECTROCHEMICAL EXFOLIATION OF GRAPHENE IN BINARY SOLVENT SYSTEM

(71) Applicant: Georgia Tech Research Corporation, Atlanta, GA (US)

(72) Inventors: Seung Woo LEE, Atlanta, GA (US); Hoyoung LEE, Atlanta, GA (US); Kyungbin LEE, Atlanta, GA (US); Minsu KIM, Atlanta, GA (US)

(21) Appl. No.: 19/384,256

(22) Filed: Nov. 10, 2025

Related U.S. Application Data
(60) Provisional application No. 63/718,145, filed on Nov. 8, 2024.

(51) Int. Cl. C25B 1/135; C25B 11/043; H01M 10/0525

(52) U.S. Cl. CPC C25B 1/135; C25B 11/043; H01M 10/0525

(57) ABSTRACT

The present disclosure provides methods of producing isolated graphene sheets from graphite. Isolated graphene sheets produced by said methods, as well as articles and devices containing said isolated graphene sheets, are also provided. Electrochemical intercalation reactors for performing said methods are also provided.

### CROSS-REFERENCE TO RELATED APPLICATIONS

This application claims the benefit of priority to U.S. Provisional Patent Application No. 63/718,145, filed Nov. 8, 2024, the disclosure of which is incorporated herein by reference in its entirety.

### STATEMENT REGARDING FEDERALLY SPONSORED RESEARCH OR DEVELOPMENT

This invention was made with government support under 1751693 awarded by the National Science Foundation. The government has certain rights in the invention.

### BACKGROUND

Graphene, a two-dimensional material composed of a single layer of carbon atoms, has garnered significant attention due to its unique electrical, thermal, and mechanical properties. Its potential applications span various fields, including electronics, sensors, and energy storage devices. However, the challenge of producing high-quality graphene at a low cost and on a large scale remains a significant barrier to its widespread adoption. Traditional methods, such as chemical vapor deposition and chemical exfoliation, either fail to meet the necessary quality standards or introduce defects that limit the material's performance. Therefore, there is a pressing need for innovative approaches to graphene production that can provide high-quality material with controlled structural properties.

Among the various methods for graphene production, electrochemical exfoliation has gained attention for its simplicity, environmental friendliness, and scalability. Unlike chemical vapor deposition (CVD), which requires high temperatures and sophisticated equipment, or chemical exfoliation, which often involves hazardous chemicals and complex procedures, electrochemical exfoliation offers a more straightforward approach. It uses an electrical potential to intercalate ions between the graphene layers of graphite, causing them to separate into individual graphene sheets.

Cathodic exfoliation has challenges, particularly in controlling the number of graphene layers and ensuring uniformity across the produced sheets. Traditional methods often result in a mix of single-layer and multi-layer graphene, with varying degrees of defects. This lack of control over the exfoliation process limits the material's applicability in high-performance devices, where specific layer thickness and purity are essential.

This disclosure addresses the above, as well as other needs.

### SUMMARY

The present disclosure provides methods, articles and devices for implementing said methods, compositions produced by said methods, and articles and devices including such compositions. In particular, the present disclosure provides methods of producing graphene, electrochemical exfoliation reactors for producing said graphene, graphene produced by said methods, and articles and devices including said graphene.

In one aspect, a method is provided for producing isolated graphene sheets from graphite. In some aspects, the graphite contains therein hexagonal carbon atomic interlayers with an interlayer spacing. In some aspects, the method includes forming an intercalated graphite compound by an electrochemical intercalation procedure conducted in an electrochemical reactor. In some aspects, the reactor includes a solution comprising an intercalating electrolyte, a first solvent, and a second solvent. In some aspects, the reactor includes a working electrode comprising the graphite in contact with the solution. In some aspects, the reactor includes a counter electrode in contact with the solution. In some aspects, a current can be imposed to effect electrochemical intercalation of the intercalating electrolyte into the interlayer spacing. In some aspects, the method further includes exfoliating and separating the hexagonal carbon atomic interlayers from the intercalated graphite compound to produce the isolated graphene sheets.

In some aspects, the isolated graphene sheets include single-layer graphene sheets. In some aspects, the isolated graphene sheets include few-layer graphene sheets including from about 2 to about 10 layers.

In some aspects, the first solvent and the second solvent can be present in a ratio of about 1:2 of the first solvent to the second solvent.

In some aspects, the first solvent includes dimethyl sulfoxide (DMSO).

In some aspects, the intercalating electrolyte includes a cation selected from an alkali metal cation, a magnesium cation, or a quaternary ammonium cation. In some aspects, intercalating electrolyte includes a lithium cation, a sodium cation, a potassium cation, a magnesium cation, a tetramethylammonium cation, a tetraethylammonium cation, a tetrabutyl ammonium cation, or a tetraheptylammonium cation. In some aspects, the intercalating electrolyte includes a lithium ion. In some aspects, the cation can form a complex with DMSO, wherein said complex intercalates into the interlayer spacing. In some aspects, the intercalating electrolyte includes an anion selected from a chloride anion, a bromide anion, a perchlorate anion, a sulfate anion, a nitrate anion, or a hydroxide anion. In some aspects, the intercalating electrolyte includes a perchlorate anion. In some aspects, the intercalating electrolyte comprises lithium perchlorate. In some aspects, the intercalating electrolyte can have a concentration in the solution from about 0.1 M to about 1 M. In some aspects, the second solvent includes dimethyl carbonate (DMC).

In some aspects, the first solvent and the second solvent can reduce a solvation number of the intercalating electrolyte compared to a solvation number of the intercalating electrolyte in the first solvent or the second solvent alone.

In some aspects, the working electrode is a cathode. In some aspects, the graphite included at the working electrode can be in the form of a foil, rod, powder, or sheet.

In some aspects, the counter electrode is an anode. In some aspects, the anode can be platinum foil, a graphite rod or foil, or lithium foil.

In some aspects, the current is a direct current. In some aspects, electrochemical intercalation can occur at a voltage from about −5 V to about −10V.

In another aspect, a plurality of graphene sheets is provided produced by a method described herein.

In another aspect, an article or device is provided comprising a plurality of graphene sheets produced by a method described herein. In some aspects, the device comprises an electrode, an electrochemical cell, or a battery. In some aspects, the device comprises a lithium ion battery.

In another aspect, an electrochemical intercalation reactor is provided. In some aspects, the reactor includes a solution comprising an intercalating electrolyte, a first solvent, and a second solvent. In some aspects, the reactor includes a working electrode comprising graphite in contact with the solution. In some aspects, the reactor includes a counter electrode in contact with the solution.

The details of one or more aspects of the disclosure are set forth in the accompanying drawings and the description below. Other features, objects, and advantages of the disclosure will be apparent from the description, the drawings, and the claims.

### DESCRIPTION OF DRAWINGS

FIG. 1A provides a schematic illustration of the setup for cathodic exfoliation of graphite foil in binary solvent. FIG. 1B depicts and provides data regarding the time measured for full delamination of graphite in 0.1 M LiClO4/(DMSO:DMC by vol.).

FIG. 1C depicts a scheme of graphite cathodic exfoliation process in binary solvent.

FIGS. 2A-2H depict: SEM (FIG. 2A, FIG. 2B, and FIG. 2C) and TEM (FIG. 2E and FIG. 2F) images of exfoliated graphite/graphene particles from 0.1 M LiClO4 in binary solvents: DMSO:DMC (by vol.) (FIG. 2G) STEM image of graphene obtained from 0.1 M LiClO₄/in DMSO:DMC (1:2 by vol.), with the inset showing the height profile across the red arrow. (FIG. 2D) Size analysis of exfoliated graphene particles from binary solvents. (FIG. 2H) AFM image and height profiles of electrochemically exfoliated graphene in the binary solvent of 0.1 M LiClO₄/DMSO:DMC(1:2 by vol.).

FIGS. 3A-3D provide gas spectra during electrochemical exfoliation of graphite working electrode, Pt wire counter electrode in (FIG. 3A) 0.1 M LiClO₄/DMSO and (FIG. 3B) 0.1 M LiClO4/DMSO:DMC (1:2 by vol.). (FIG. 3C and FIG. 3D) Working electrodes are replaced with Pt wires for (FIG. 3A) and (FIG. 3B) respectively.

FIGS. 4A-4D provide (FIG. 4A) Raman spectrum, (FIG. 4B) XPS survey scan, (FIG. 4C) high-resolution C1s, and (FIG. 4D) high-resolution O1s scan of graphite foil and electrochemically exfoliated graphene in the binary solvent of 0.1 M LiClO₄/DMSO:DMC(1:2 by vol.).

FIG. 5A provides a physical image of EGBS12 on top of a PP separator with SEM top and side images. FIG. 5B provides a schematic illustration of the assembled battery cell with a Li metal anode, EGBS-coated PP separator, and LFP cathode. FIG. 5C depicts the cycling performance of the full cells with different EGBS-coated PP separators. FIGS. 5D-5F provide the corresponding charge/discharge profiles of the cells with (FIG. 5D) EGBS12, (FIG. 5E) EGBS11, and (FIG. 5F) EGBS10. FIG. 5A=3.9b; FIG. 5C-5F=4.2

FIG. 6 provides Raman spectra of 0.1 M LiClO₄ in binary solvents.

FIGS. 7A-7B provide mass spectra during the electrolysis of 0.1 M LiClO₄/DMSO using (FIG. 7A) Pt/Pt and (FIG. 7B) Pt/GF electrodes.

FIGS. 8A-8B provide mass spectra during the electrolysis in binary solvent of 0.1 M LiClO₄/DMSO:DMC (1:2 by vol) using (FIG. 8A) Pt/Pt and (FIG. 8B) Pt/GF electrodes.

FIG. 9 provides a schematic illustration of proposed mechanisms of electrochemical exfoliation.

FIG. 10 provides photographs of porous polypropylene membrane and vacuum filtered graphene flakes from electrochemical exfoliation in 0.1 LiClO₄/DMSO:DMC (1:0, 1:1, and 1:2 by volume) on the membrane from left to right.

FIGS. 11A-11B provide (FIG. 11A) Raman spectrum and (FIG. 11B) survey scan from XPS of graphite foil and electrochemically exfoliated graphene flakes in binary solvents.

FIG. 12 provides Raman spectra of exfoliated graphene flakes on coated separator.

FIG. 13 provides a photograph of setup for electrochemical exfoliation of graphite foil (working electrode) in 1 M LiTFSI/DMSO:DMC (1:2 by vol). The color of the electrolyte turned yellow from white under −20 V (vs. Pt counter electrode).

FIG. 14 provides high-resolution XPS C is, F is, and Li is scans of 0.1 M and 0.5 M LiTFSI/DMSO:DMC (1:2 by vol).

FIG. 15 depicts long-term cycling at 1 mA cm⁻² for 1 mAh cm² of symmetrical Li—Li cells with 1 M LiPF₆/EC:DEC (1:1 v/v %)+5 wt. % electrolyte.

FIGS. 16A-16C depict (FIG. 16A) Cycling performance of the full cells as a function of cycle number in the voltage range of 2.5-4.0 V at 3 mA cm⁻². Voltage profiles of (FIG. 16B) Li/G/LiTFSI/LFP cell and (FIG. 16C) Li/LiTFSI/LFP cell at 3 mA cm⁻².

FIG. 17 provides a scheme of reaction from TAPB (1,3,5-tris(4-aminophenyl)benzene) and PDA (terephthalaldehyde) for TAPB-PDA COF.

FIG. 18A-18B provide (FIG. 18A) Schematic illustration of the interfacial polymerization of TAPB-PDA COF. (FIG. 18B) Photographs of a TAPB-PDA COF (left) and TAPB-PDA COF-Graphene (right) coated on PP separator.

FIG. 19 provides a Fourier-transform infrared (FTIR) spectra of TAPB-PDA COF and TAPB-PDA-COF-G.

FIGS. 20A-20C provide SEM images of (FIG. 20A) top-view of PP separator and COF-G coated on PP separator (FIG. 20B) top view and (FIG. 20C) cross-sectional side view.

FIGS. 21A-21C depict (FIG. 21A) Cycling performance of the full cells as a function is of cycle number in the voltage range of 2.5-4.0 V at 1 C (1 C=170 mAh g⁻¹). Voltage profiles of (FIG. 21B) Li∥ ∥LiPF₆∥LFP cell and (FIG. 21C) Li∥COF-G∥LiPF₆∥LFP cell at 1 C.

### DETAILED DESCRIPTION

The following description of the disclosure is provided as an enabling teaching of the disclosure in its best, currently known aspects. Many modifications and other aspects disclosed herein will come to mind to one skilled in the art to which the disclosed compositions and methods pertain, benefiting from the teachings presented in the descriptions herein and the associated drawings. Therefore, it is understood that the disclosures are not limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As is apparent to those of skill in the art upon reading this disclosure, each of the individual aspects described and illustrated herein has discrete components and features that may be readily separated from or combined with the features of any of the other several aspects without departing from the scope or spirit of the present disclosure.

Any recited method can be carried out in the order of events recited or any other order that is logically possible. Unless otherwise expressly stated, it is in no way intended that any method or aspect set forth herein be construed as requiring that its steps be performed in a specific order. Accordingly, where a method claim does not explicitly state in the claims or descriptions that the steps are to be limited to a particular order, it is in no way intended that an order be inferred in any respect. This holds for any possible non-express basis for interpretation, including logic concerning the arrangement of steps or operational flow, meaning derived from grammatical organization or punctuation, or the number or type of aspects described in the specification.

All publications mentioned herein are incorporated by reference to disclose and describe the methods or materials in connection with which the publications are cited. The publications discussed herein are provided solely for their disclosure before the filing date of the present application. Further, the dates of publication provided herein can be different from the actual publication dates, which can require independent confirmation.

It is also to be understood that the terminology herein describes particular aspects only and is not intended to be limiting. Unless defined otherwise, all technical and scientific terms herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Before describing the various aspects of the present disclosure, the following definitions are provided and should be used unless otherwise indicated. Additional terms may be defined elsewhere in the present disclosure.

### Definitions

As used herein, “comprising” is interpreted as specifying the presence of the stated features, integers, steps, or components, but does not preclude the presence or addition of one or more features, integers, steps, components, or groups thereof. Moreover, each of the terms “by,” “comprising,” “comprises,” “comprised of,” “including,” “includes,” “included,” “involving,” “involves,” “involved,” and “such as” is used in its open, non-limiting sense and may be used interchangeably. Further, the term “comprising” is intended to include examples and aspects encompassed by the terms “consisting essentially of” and “consisting of.” Similarly, “consisting essentially of” is intended to include examples encompassed by the term “consisting of.”

As used in the specification and the appended claims, the singular forms “a,” “an,” and “the” include plural referents unless the context dictates otherwise.

Ratios, concentrations, amounts, and other numerical data can be expressed herein in a range format. Further, the endpoints of each of the ranges are significant both in relation to the other endpoint and independently of the other endpoint. There are many values disclosed herein, and each value is also disclosed as “about” that particular value in addition to the value itself. For example, if the value “10” is disclosed, then “about 10” is also disclosed. Ranges can be expressed herein as from “about” one particular value and to “about” another particular value. Similarly, when values are expressed as approximations, using the antecedent “about,” the particular value forms a further aspect. For example, if the value “about 10” is disclosed, then “10” is also disclosed.

When a range is expressed, a further aspect includes from the one particular value and to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x,’ ‘about y,’ and ‘about z’ as well as the ranges of ‘less than x,’ ‘less than y.’ and ‘less than z.’ Likewise, the phrase ‘about x, y, z, or greater’ should be interpreted to include the specific ranges of ‘about x,’ ‘about y,’ and ‘about z’ as well as the ranges of ‘greater than x,’ greater than y,’ and ‘greater than z.’ In addition, the phrase “about ‘x’ to ‘y’,” where ‘x’ and ‘y’ are numerical values, includes “about ‘x’ to about ‘y’.”

Such a range format is used for convenience and brevity and thus, should be interpreted flexibly to include not only the numerical values explicitly recited as the limits of the range but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that is provides equivalent results or effects as recited in the claims or taught herein. That is, amounts, sizes, formulations, parameters, and other quantities and characteristics are not and need not be exact but may be approximate, larger or smaller, as desired, reflecting tolerances, conversion factors, rounding, measurement error, and the like, and other factors known to those of skill in the art such that equivalent results or effects are obtained. In some circumstances, the value that provides equivalent results or effects cannot be reasonably determined. In such cases, as used herein, “about” and “at or about” mean the nominal value indicated ±10% variation unless otherwise indicated or inferred. In general, an amount, size, formulation, parameter, or other quantity or characteristic is “about,” “approximate,” or “at or about,” whether or not expressly stated to be such. Where “about,” “approximate,” or “at or about” is used before a quantitative value, the parameter also includes the specific quantitative value itself unless expressly stated otherwise.

As used herein, “optional” or “optionally” means that the subsequently described event or circumstance can or cannot occur. The description includes instances where said event or circumstance occurs and those where it does not.

Although the operations of exemplary aspects of the disclosed method may be described in a particular sequential order for convenient presentation, it should be understood that disclosed aspects can encompass an order of operations other than the particular sequential order disclosed. For example, operations described sequentially may, in some cases, be rearranged or performed concurrently. Further, descriptions and disclosures provided in association with one particular aspect are not limited to that aspect and may be applied to any aspect disclosed.

The terms “coupled” and “associated” generally mean electrically, electromagnetically, and/or physically (e.g., mechanically or chemically) coupled or linked and do not exclude the presence of intermediate elements between the coupled or associated items.

It will be understood that when an element is referred to as being “connected” or “coupled” to another element, it can be directly connected or coupled to the other element, or intervening elements can be present. In contrast, when an element is referred to as being “directly connected” or “directly coupled” to another element, there are no intervening elements present. Other words used to describe the relationship between elements or layers should be interpreted in a like fashion (e.g., is “between” versus “directly between,” “adjacent” versus “directly adjacent,” “on” versus “directly on”).

It will be understood that although the terms “first,” “second,” etc., can be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example aspects.

Spatially relative terms, such as, ““beneath,” “below,” “lower,” “above,” “upper,” “upward,” “downward,” “top,” “bottom,” and the like, can be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations), and the spatially relative descriptors used herein are interpreted accordingly.

Terms such as “proximal,” “distal,” “radially outward,” “radially inward,” “outer,” “inner,” and “side” describe the orientation and/or location of portions of the components or elements within a consistent but arbitrary frame of reference which is made clear by reference to the text and the associated drawings describing the components or elements under discussion. Such terminology can include the words specifically mentioned above, derivatives thereof, and words of similar import. Similarly, the terms “first,” “second,” and other such numerical terms referring to structures neither imply a sequence nor order unless clearly indicated by the context.

As used herein, “bulk material” refers to a macroscopic, three-dimensional solid in which properties are not governed by nanoscale confinement. Bulk materials serve as the feedstock or precursor reservoir from which atomically thin layers are is produced by exfoliation. In some aspects, the bulk material denotes a stacked crystal composed of many covalently bonded planes held together by interlayer van der Waals forces, prior to their isolation as monolayers or few-layers.

As used herein, a “two-dimensional (2D) material” refers to a material comprising one or more layers of atoms in which atoms within each layer are strongly bonded to neighboring atoms in the same layer, the material having a thickness that is in the nanoscale or smaller (e.g., approximately one to several atomic layers), with lateral in-plane dimensions exceeding the nanoscale. Such materials can include monolayer and few-layer forms derived from layered solids and may exhibit weak interlayer interactions when stacked into multiple layers.

As used herein, “graphite” refers to a crystalline allotrope of elemental carbon comprising two-dimensional graphene layers in a hexagonal lattice stacked substantially parallel to one another to form a three-dimensional structure exhibiting long-range order, wherein each carbon atom is three-coordinate (sp2 hybridized) within a layer and adjacent layers are associated by interlayer interactions; unless otherwise specified, the term encompasses both natural and synthetic graphite and includes commercially recognized categories such as flake, vein, amorphous (microcrystalline), and artificial/synthetic molded grades.

As used herein, “graphene” or “monolayer graphene” refers to a single atomic layer of sp2-bonded carbon atoms arranged in a two-dimensional hexagonal lattice, each carbon bonded to three nearest neighbors. “Few layer graphene” refers to a nanomaterial consisting of two to ten stacked graphene layers.

### Electrochemical Exfoliation of 2D Materials

Two-dimensional (2D) materials, triggered by the discovery of graphene, have been applied in a wide variety of fields over the past decade due to their superior properties. Graphene is well-known to be a paradigm of atomically thin 2D materials with exceptional mechanical, thermal, optoelectronic, and electrical properties. The rise of graphene has greatly inspired the exploration of other classes of 2D materials, including black phosphorus, transition metal dichalcogenides (TMDs), hexagonal boron nitride (h-BN), transition metal oxides (TMOs), metal carbides or nitrides (MXenes), and covalent organic frameworks (COFs). The outstanding properties of these 2D materials have led to great success in applications such as energy storage devices, electrochemical sensors, and field effect transistors. Although 2D materials have had a significant impact on a broad range of applications, industrial-level scalability, and high-quality structural control are still required for commercialization.

Since Geim and Novoselov successfully isolated high-quality graphene from highly oriented pyrolytic graphite (HOPG) by micro-mechanical cleavage in 2004, many researchers have explored a wide range of techniques for producing atomically thin nanomaterials. Numerous 2D materials production methods have been reported, which are simply categorized into two strategies: bottom-up and top-down. Bottom-up techniques such as epitaxial growth, chemical or hydrothermal/solvothermal synthesis, molecular beam epitaxy, and chemical vapor deposition (CVD) build monolayer or few-layer sheets starting from molecular precursors. In general, 2D materials synthesized by bottom-up techniques have large grain sizes and high quality. However, bottom-up synthetic procedures typically require expensive equipment operating under harsh conditions (e.g., high temperature and pressure) and have difficulties in transferring samples to other substrates for post-synthesis processing. On the other hand, top-down methods such as mechanical cleavage with scotch tape, wet chemical oxidation, liquid-phase sonication, and electrochemical exfoliation are based on exfoliation from bulk crystals or powders. The different bond strength between weak Van der Waals interactions along the adjacent plane and strong covalent bonds along the basal plane atoms enables layer-by-layer extraction by external force or intercalation. Mechanical exfoliation can achieve high-quality 2D materials on small scales that limit their use on a laboratory scale for fundamental study. Wet chemical oxidation and liquid-phase sonication assisted by sheer forces are facile and cost-effective methods to generate solution-processable 2D materials. However, such processes are typically time-consuming, often employ hazardous chemicals, and provide limited control over the structure of the resulting 2D materials.

Electrochemical exfoliation, a top-down strategy, enables efficient and large-scale production of 2D materials while maintaining high quality comparable to those produced from bottom-up techniques. This process is based on a collective phenomenon consisting of ion intercalation, chemical oxidation or reduction, gas evolution, mechanical expansion, and exfoliation. Various ions under an electric field can intercalate into most types of bulk layered materials to reduce intermolecular interactions between layers, and subsequent gas evolution from the co-intercalated solvent molecules causes expansion and exfoliation of the 2D materials. These processes take only several minutes to hours to synthesize solution-processable 2D materials. The electrochemical exfoliation method enables sophisticated control over the exfoliated materials by utilizing electromotive forces compared to other chemical or mechanical driving forces for exfoliation, which is a significant advantage for 2D materials used in electronic devices where structural integrity is a critical factor. In addition, this method involves various processing parameters (i.e., quality of starting materials, concentration and types of anions or cations, solvents, voltage, time, etc.). Owing to these advantages, 2D materials produced by electrochemical exfoliation have been used in a variety of applications, such as electrocatalysts, batteries, supercapacitors, sensors, passivation layer and organic field-effect transistors. In this review, we introduce several types of electrochemical exfoliation setups and discuss the exfoliation mechanism along with examples of graphene and other 2D materials such as MoS₂ and black phosphorus. We then introduce how electrochemically exfoliated 2D materials can be used as electrode materials in various energy storage devices. Finally, we discuss the various challenges and emerging opportunities for the electrochemical exfoliation process of 2D materials for energy storage applications.

A typical setup for an electrochemical exfoliation process includes a working electrode (WE) which is the bulk materials to be exfoliated, a counter electrode (CE), which is usually a metal plate or wire, a reference electrode (RE), an electrolyte and a power supply. During the exfoliation process, a fixed potential or electrical current causes the guest ions in the solvent to move into the space between the layers of the 2D material. Depending on the potential applied to the working electrode, the guest ions can be anions with a positive potential (anodic exfoliation) or cations with a negative potential (cathodic exfoliation). In general, anodic exfoliation is advantageous for producing 2D materials with high yields, exhibits high exfoliation efficiency, and is accompanied by functionalization of the products by oxidation (i.e., halide ions, organic compounds, non-metals, metals, and metal oxides). Whereas cathodic exfoliation can produce high-quality 2D materials but with a relatively lower rate. In addition, a dual exfoliation technique has been developed to simultaneously exfoliate 2D materials from both the cathode and anode.

Anodic exfoliation involves the insertion of negatively charged anions into 2D materials at the working electrode, which can occur in either aqueous or organic solvent environments. The initial achievement of electrochemical exfoliation was realized through anodic exfoliation of graphite in ionic liquids. Wang et al. applied a consistent voltage of 5 V to two graphite rods, which acted as both anode and cathode, in a 0.001 M poly(sodium-4-styrenesulfonate) (PSS) aqueous solution. After 20 minutes, black-colored graphene started to form. In this procedure, polystyrenesulfonate anions were employed as both intercalants and surfactants. Subsequently, Su et al. showcased the electrochemical exfoliation of highly oriented pyrolytic graphite (HOPG) and natural graphite flakes in diluted sulfuric acid (0.5 M, pH=0.3), which was inspired by a 1996 report on using concentrated sulfuric acid (H₂SO₄) to create expandable graphite. The graphene sheets obtained in this research had a thickness below 3 nm and a maximum size of 30 μm. It was noted that the exfoliation process was slow and efficient at low voltages (<10 V), but rapid and non-uniform at high voltages (>25 V). In 2013, Feng's group successfully produced a high proportion of few-layer graphene by employing defective graphite foils that allowed anion intercalation in 0.1 M H₂SO₄, resulting in over 60% of the total starting graphite materials. The electrochemically exfoliated graphene sheets had a lateral size of approximately 10 μm and a carbon-to-oxygen (C/O) atomic ratio of 12.3. Later, the same group conducted electrochemical exfoliation of natural graphite flakes in various aqueous inorganic salts, including (NH₄)₂SO₄, Na₂SO₄, K₂SO₄, NH₄Cl, NaNO₃, and NaClO₄. Salts containing sulfate anions (SO₄²⁻) demonstrated superior performance compared to other anions, requiring only 5 minutes to exfoliate graphite flakes into thin graphene sheets. Ammonium sulfate ((NH₄)₂SO₄) under neutral pH conditions yielded a high percentage of graphene exfoliation (>85 wt. %) with lateral sizes reaching up to 44 μm and a high C/O ratio of 17.2.

Anodic exfoliation facilitates a highly efficient method for producing 2D materials at significant rates; however, oxidation of the resulting product is inescapable. This may pose a significant challenge for applications like electronics that demand unoxidized, pure 2D materials. In order to maintain the inherent properties of 2D materials, cathodic exfoliation emerges as a promising approach. As a non-oxidative exfoliation technique, it applies a negative potential to the layered material, enabling the intercalation of negatively charged ions.

In rechargeable lithium-ion battery (LIB) systems, Li+ ions are reversibly integrated into the graphite anode, which serves as the lithium host. However, during charging and discharging, the co-intercalation of solvent results in a loss of reversibility and significant volume changes in the graphite electrode. This expansion causes undesired exfoliation of the graphite in the battery system. Taking inspiration from this occurrence, Wang et al. described the cathodic exfoliation of graphite in a non-aqueous electrolyte composed of LiClO₄ and propylene carbonate (PC). The co-intercalation of PC solvent and Li+(Li⁺:2PC and Li⁺:3PC) was observed at high potentials of −15±5 V. The expanded graphite was subsequently washed with acid and water to separate individual layers, with hydrogen gas evolution assisting the process (Li+2H₂O→2LiOH+H₂). Zheng et al. produced semiconducting 2D materials like MoS₂, WS₂, TiS₂, TaS₂, and ZrS₂ by controlling the lithiation and sonication processes of the intercalated compounds in the aqueous phase. The lithiation process was carried out in a battery test system using a Li foil anode as a Li-ion source. After the lithium intercalation process, which involved galvanostatic discharge at a current density of 0.05 mA, the Li-intercalated 2D materials were rinsed with acetone and subjected to ultrasonication in water for further exfoliation. In 2018, few-layer silicene nanosheets were also produced through consecutive electrochemical lithiation and delithiation processes. Initially, Si nanopowders were lithiated in Li-ion coin cells via a discharging process. Following delithiation by washing with deionized water or isopropyl alcohol, graphite-like “siliphite” or a few silicene layers were formed, respectively. The authors suggested that the varying exfoliation phenomena were attributable to different delithiation kinetics based on proton concentration.

As an alternative to the smaller Li⁺ ion (diameter: ˜0.18 nm), larger tetra-alkyl ammonium (TAA⁺) cations like tetramethylammonium (TMA⁺, diameter: ˜0.558 nm), tetra-ethyl-ammonium (TEA⁺, diameter: ˜0.674 nm), and tetra-n-butyl-ammonium (TBA⁺, diameter: ˜0.826 nm) have been employed as intercalating agents for cathodic intercalation. Zhong and Swager initially demonstrated a two-step intercalation of Li⁺ and TBA⁺ into graphite. Graphite was first expanded by the smaller Li⁺ ions and subsequently further expanded by replacing Li⁺ ions with the larger TBA⁺ cations. Later, Yang et al. investigated the electrochemical exfoliation of graphite rod and highly oriented pyrolytic graphite (HOPG) in TBA⁺-containing electrolytes with various organic solvents, including acetonitrile (AN), N,N-dimethylformamide (DMF), and propylene carbonate (PC). The authors proposed that efficient graphite exfoliation was achieved through both the intercalation of solvated cations into graphite and the resulting gas bubbling from the decomposition of the electrolyte.

Lithium-ion batteries (LIBs) are commonly used as power sources for electric devices, vehicles, and grid applications. The state-of-the-art LIBs use graphite anode, which has a theoretical capacity of ˜372 mAh g⁻¹ and has almost reached its theoretical specific energy density of ˜350 Wh kg⁻¹. However, they are still limited in providing the energy density required for long-range electric vehicles. Lithium metal batteries (LMBs) with lithium metal as anode have the lowest electrochemical potential (−3.04 V vs standard hydrogen electrode) and the highest theoretical specific capacity (3,860 mAh g⁻¹) among the various existing battery technologies. Therefore, LMBs have gained attention as the ultimate choice of anode materials to satisfy the urgent needs of batteries with superior performance over the LIBs.

The use of lithium metal anode in LMBs results in the following challenges: (1) uncontrolled growth of Li dendrites which poses significant safety risks, (2) the Li metal's thermodynamic instability leads to irreversible reactions between Li and electrolyte, causing the formation of thick solid electrolyte interphase (SEI) layers on the Li metal surface. This consumes Li and electrolyte, increases internal resistance, and reduces cycle life. (3) During repeated plating/stripping cycles, the Li metal anode can undergo significant volumetric and morphological changes.

Different physical and chemical methods have been studied to prevent the formation of lithium dendrites in batteries. One of these methods is to attach electrically conductive hosts with high specific surface area to Li metal, such as reduced graphene oxide, doped graphene, and 3D porous skeletons, to regulate lithium nucleation for a uniform electrode surface during lithium electrodeposition. There are also many strategies for controlling dendrite structures, pathways, and directions, including electrolyte additives, artificial SEI protective layers, high-mechanical-modulus solid-state electrolytes, polymer electrolyte with high cationic transference number, etc. All these methods aim to control the lithium deposition behavior and electrochemical reaction during battery operation, thereby obtaining optimized cycling coulombic efficiency (CE) and reducing the risk of battery failure. Other solutions to address the problems associated with lithium metal anode include is incorporating additives into the electrolyte or anode to create a stable solid electrolyte interphase (SEI) layer on the anode surface, generating an artificial SEI, utilizing solid electrolytes, implementing 3D anode hosts, applying coatings, using binders, and utilizing separators.

The present disclosure provides methods of producing isolated graphene sheets from graphite. In some aspects, the graphene sheets can be single-layer graphene sheets and/or few-layer graphene sheets. In some aspects, the graphite includes hexagonal carbon atomic layers. In some aspects, the hexagonal carbon atomic layers have an interlayer spacing.

In some aspects, the method can include forming an intercalated graphite compound by electrochemical intercalation conducted in an electrochemical reactor.

In some aspects, the reactor includes a solution. In some aspects, the solution includes an intercalating electrolyte. In some aspects, the intercalating electrolyte can include an alkali metal cation. In some aspects, the alkali metal cation can be lithium (Li⁺), sodium (Na⁺), or potassium (K⁺). In some aspects, the intercalating electrolyte can include a quaternary ammonium cation. In some aspects, the quaternary ammonium cation can include tetramethylammonium (TMA⁺), tetraethylammonium (TEA⁺), tetrabutylammonium (TBA⁺), tetraheptylammonium (THA⁺), or other alkyl-substituted quaternary ammonium compounds. In some aspects, the intercalating electrolyte can include a divalent cation (such as magnesium, i.e., Mg²⁺). In some aspects, the intercalating electrolyte can include an alkyl pyrrolidinium or imidazolium cation. In some aspects, the intercalating electrolyte can include an anion, such as a halide (i.e., chloride Cl⁻ or bromide Br⁻), perchlorate (ClO₄⁻), sulfate (SO₄²⁻), nitrate (NO₃⁻), or hydroxide (OH⁻). In some aspects, the intercalating electrolyte can be selected from lithium chloride, sodium chloride, potassium chloride, magnesium chloride, tetramethylammonium chloride, tetraethylammonium chloride, tetrabutylammonium chloride, tetraheptylammonium chloride, lithium bromide, sodium bromide, potassium bromide, magnesium bromide, tetramethylammonium bromide, tetraethylammonium bromide, tetrabutylammonium bromide, tetraheptylammonium bromide, lithium perchlorate, sodium perchlorate, potassium perchlorate, magnesium perchlorate, tetramethylammonium perchlorate, tetraethylammonium perchlorate, tetrabutylammonium perchlorate, tetraheptylammonium perchlorate, lithium sulfate, sodium sulfate, potassium sulfate, magnesium sulfate, tetramethylammonium sulfate, tetraethylammonium sulfate, tetrabutylammonium sulfate, tetraheptylammonium sulfate, lithium nitrate, sodium nitrate, potassium nitrate, magnesium nitrate, tetramethylammonium nitrate, tetraethylammonium nitrate, tetrabutylammonium nitrate, tetraheptylammonium nitrate, lithium hydroxide, sodium hydroxide, potassium hydroxide, magnesium hydroxide, tetramethylammonium hydroxide, tetraethylammonium hydroxide, tetrabutylammonium hydroxide, and tetraheptylammonium hydroxide.

In some aspects, the intercalating electrolyte can have a concentration in the solution from about 0.1 M to about 1 M, including exemplary values of about 0.1 M, about 0.2 M, about 0.3 M, about 0.4 M, about 0.5 M, about 0.6 M, about 0.7 M, about 0.8 M, about 0.9 M, about 1 M, or any subrange formed from the above exemplary values. In some aspects, the intercalating electrolyte can have a concentration in the solution from about 0.1 M to about 0.2 M, from about 0.1 M to about 0.3 M, from about 0.1 M to about 0.4 M, from about 0.1 M to about 0.5 M, from about 0.1 M to about 0.6 M, from about 0.1 M to about 0.7 M, from about 0.1 M to about 0.8 M, from about 0.1 M to about 0.9 M, from about 0.1 M to about 1 M, from about 0.2 M to about 0.3 M, from about 0.2 M to about 0.4 M, from about 0.2 M to about 0.5 M, from about 0.2 M to about 0.6 M, from about 0.2 M to about 0.7 M, from about 0.2 M to about 0.8 M, from about 0.2 M to about 0.9 M, from about 0.2 M to about 1 M, from about 0.3 M to about 0.4 M, from about 0.3 M to about 0.5 M, from about 0.3 M to about 0.6 M, from about 0.3 M to about 0.7 M, from about 0.3 M to about 0.8 M, from about 0.3 M to about 0.9 M, from about 0.3 M to about 1 M, from about 0.4 M to about 0.5 M, from about 0.4 M to about 0.6 M, from about 0.4 M to about 0.7 M, from about 0.4 M to about 0.8 M, from about 0.4 M to about 0.9 M, from about 0.4 M to about 1 M, from about 0.5 M to about 0.6 M, from about 0.5 M to about 0.7 M, from about 0.5 M to about 0.8 M, from about 0.5 M to about 0.9 M, from about 0.5 M to about 1 M, from about 0.6 M to about 0.7 M, from about 0.6 M to about 0.8 M, from about 0.6 M to about 0.9 M, from about 0.6 M to about 1 M, from about 0.7 M to about 0.8 M, from about 0.7 M to about 0.9 M, from about 0.7 M to about 1 M, from about 0.8 M to about 0.9 M, from about 0.8 M to about 1 M, and from about 0.9 M to about 1 M.

In some aspects, the solution can include a first solvent. In some aspects, the solution can include a second solvent. In some aspects, the first solvent and the second solvent can have a ratio. In some aspects, the ratio of the first solvent to the second solvent can be from about 2:1 to about 1:2. including exemplary values of about 2:1, about 3:2, about 1:1, about 2:3, about 1:2, or any subrange formed from the above exemplary values. In some aspects, the ratio of the first solvent to the second solvent can be from about 2:1 to about 3:2, from about 2:1 to about 1:1, from about 2:1 to about 2:3, from about 2:1 to about 1:2, from about 3:2 to about 1:1, from about 3:2 to about 2:3, from about 3:2 to about 1:2, from about 1:1 to about 2:3, from about 1:1 to about 1:2, or from about 2:3 to about 1:2.

In some aspects, the first solvent and the second solvent can reduce a solvation number of the intercalating electrolyte compared to a solvation number of the intercalating electrolyte in the first solvent or the second solvent alone.

In some aspects, the first solvent can include dimethyl sulfoxide. In some aspects, the cation of the intercalating electrolyte can form a complex with DMSO, said complex intercalating into the interlayer spacing. In some aspects, the cation is lithium, wherein lithium of the intercalating electrolyte can form a complex with DMSO, said complex intercalating into the interlayer spacing. In some aspects, the intercalating electrolyte can include lithium perchlorate.

In some aspects, the second solvent can include dimethyl carbonate.

In some aspects, the reactor can include a working electrode. In some aspects, the working electrode can be a cathode. In some aspects, the working electrode includes the graphite. In some aspects, the graphite included in the working electrode can be in contact with the solution. In some aspects, the graphite at the working electrode can be in the form of a foil, rod, powder, or sheet. In some aspects, the graphite at the working electrode can be highly oriented pyrolytic graphite (HOPG).

In some aspects, the reactor can include a counter electrode. In some aspects, the counter electrode can be an anode. Representative examples of suitable anodes include, but are not limited to, platinum foil, a graphite rod or foil, and lithium foil. In some aspects, the anode can be an impressed current anode. In some aspects, the counter electrode can be in contact with the solution.

In some aspects, a current can be imposed to effect electrochemical intercalation of the intercalating electrolyte into the interlayer spacing to form the intercalated graphite compound. In some aspects, the current can be a direct current. In some is aspects, electrochemical intercalation can occur at a voltage from about −5 V to about −10 V, including exemplary values of about −5 V, about −6 V, about −7 V, about −8 V, about −9 V, about −10 V, or any subrange formed from the above exemplary values. In some aspects, electrochemical intercalation can occur at a voltage from about −5 V to about −6 V, from about −5 V to about −7 V, from about −5 V to about −8 V, from about −5 V to about −9 V, from about −5 V to about −10 V, from about −6 V to about −7 V, from about −6 V to about −8 V, from about −6 V to about −9 V, from about −6 V to about −10 V, from about −7V to about −8 V, from about −7 V to about −9 V, from about −7 V to about −10 V, from about −8 V to about −9 V, from about −8 V to about −10 V, or from about −9 V to about −10 V.

In some aspects, the method can include exfoliating and separating the hexagonal carbon atomic interlayers from the intercalated graphite compound to produce the isolated graphene sheets.

In some aspects, the isolated graphene sheets can include single-layer graphene sheets. In some aspects, the isolated graphene sheets can include few-layer graphene sheets. In some aspects, the few-layer graphene sheets can include from about 2 layers to about 10 layers, including exemplary values of 2 layers, 3 layers, 4 layers, 5 layers, 6 layers, 7 layers, 8 layers, 9 layers, 10 layers, or any subrange formed from the above exemplary values. In some aspects, the few-layer graphene sheets can include from about 2 layers to about 3 layers, from about 2 layers to about 4 layers, from about 2 layers to about 5 layers, from about 2 layers to about 6 layers, from about 2 layers to about 7 layers, from about 2 layers to about 8 layers, from about 2 layers to about 9 layers, from about 2 layers to about 10 layers, from about 3 layers to about 4 layers, from about 3 layers to about 5 layers, from about 3 layers to about 6 layers, from about 3 layers to about 7 layers, from about 3 layers to about 8 layers, from about 3 layers to about 9 layers, from about 3 layers to about 10 layers, from about 4 layers to about 5 layers, from about 4 layers to about 6 layers, from about 4 layers to about 7 layers, from about 4 layers to about 8 layers, from about 4 layers to about 9 layers, from about 4 layers to about 10 layers, from about 5 layers to about 6 layers, from about 5 layers to about 7 layers, from about 5 layers to about 8 layers, from about 5 layers to about 9 layers, from about 5 layers to about 10 layers, from about 6 layers to about 7 layers, from about 6 layers to about 8 layers, from about 6 layers to about 9 layers, from about 6 layers to about 10 layers, from about 7 layers is to about 8 layers, from about 7 layers to about 9 layers, from about 7 layers to about 10 layers, from about 8 layers to about 9 layers, from about 8 layers to about 10 layers, or from about 9 layers to about 10 layers.

In another aspect, an electrochemical intercalation reactor is provided. In some aspects, the electrochemical intercalation reactor can be suitable for performing the methods described herein.

In some aspects, the reactor includes a solution. In some aspects, the solution includes an intercalating electrolyte. In some aspects, the intercalating electrolyte can include an alkali metal cation. In some aspects, the alkali metal cation can be lithium (Li⁺), sodium (Na⁺), or potassium (K⁺). In some aspects, the intercalating electrolyte can include a quaternary ammonium cation. In some aspects, the quaternary ammonium cation can include tetramethylammonium (TMA⁺), tetraethylammonium (TEA⁺), tetrabutylammonium (TBA⁺), tetraheptylammonium (THA⁺), or other alkyl-substituted quaternary ammonium compounds. In some aspects, the intercalating electrolyte can include a divalent cation (such as magnesium, i.e., Mg²⁺). In some aspects, the intercalating electrolyte can include an alkyl pyrrolidinium or imidazolium cation. In some aspects, the intercalating electrolyte can include an anion, such as a halide (i.e., chloride Cl⁻ or bromide Br⁻), perchlorate (ClO₄⁻), sulfate (SO₄²⁻), nitrate (NO₃⁻), or hydroxide (OH⁻). In some aspects, the intercalating electrolyte can be selected from lithium chloride, sodium chloride, potassium chloride, magnesium chloride, tetramethylammonium chloride, tetraethylammonium chloride, tetrabutylammonium chloride, tetraheptylammonium chloride, lithium bromide, sodium bromide, potassium bromide, magnesium bromide, tetramethylammonium bromide, tetraethylammonium bromide, tetrabutylammonium bromide, tetraheptylammonium bromide, lithium perchlorate, sodium perchlorate, potassium perchlorate, magnesium perchlorate, tetramethylammonium perchlorate, tetraethylammonium perchlorate, tetrabutylammonium perchlorate, tetraheptylammonium perchlorate, lithium sulfate, sodium sulfate, potassium sulfate, magnesium sulfate, tetramethylammonium sulfate, tetraethylammonium sulfate, tetrabutylammonium sulfate, tetraheptylammonium sulfate, lithium nitrate, sodium nitrate, potassium nitrate, magnesium nitrate, tetramethylammonium nitrate, tetraethylammonium nitrate, tetrabutylammonium nitrate, tetraheptylammonium nitrate, lithium hydroxide, sodium hydroxide, potassium hydroxide, magnesium hydroxide, tetramethylammonium hydroxide, tetraethylammonium hydroxide, tetrabutylammonium hydroxide, and tetraheptylammonium hydroxide.

In some aspects, the intercalating electrolyte can have a concentration in the solution from about 0.1 M to about 1 M, including exemplary values of about 0.1 M, about 0.2 M, about 0.3 M, about 0.4 M, about 0.5 M, about 0.6 M, about 0.7 M, about 0.8 M, about 0.9 M, about 1 M, or any subrange formed from the above exemplary values. In some aspects, the intercalating electrolyte can have a concentration in the solution from about 0.1 M to about 0.2 M, from about 0.1 M to about 0.3 M, from about 0.1 M to about 0.4 M, from about 0.1 M to about 0.5 M, from about 0.1 M to about 0.6 M, from about 0.1 M to about 0.7 M, from about 0.1 M to about 0.8 M, from about 0.1 M to about 0.9 M, from about 0.1 M to about 1 M, from about 0.2 M to about 0.3 M, from about 0.2 M to about 0.4 M, from about 0.2 M to about 0.5 M, from about 0.2 M to about 0.6 M, from about 0.2 M to about 0.7 M, from about 0.2 M to about 0.8 M, from about 0.2 M to about 0.9 M, from about 0.2 M to about 1 M, from about 0.3 M to about 0.4 M, from about 0.3 M to about 0.5 M, from about 0.3 M to about 0.6 M, from about 0.3 M to about 0.7 M, from about 0.3 M to about 0.8 M, from about 0.3 M to about 0.9 M, from about 0.3 M to about 1 M, from about 0.4 M to about 0.5 M, from about 0.4 M to about 0.6 M, from about 0.4 M to about 0.7 M, from about 0.4 M to about 0.8 M, from about 0.4 M to about 0.9 M, from about 0.4 M to about 1 M, from about 0.5 M to about 0.6 M, from about 0.5 M to about 0.7 M, from about 0.5 M to about 0.8 M, from about 0.5 M to about 0.9 M, from about 0.5 M to about 1 M, from about 0.6 M to about 0.7 M, from about 0.6 M to about 0.8 M, from about 0.6 M to about 0.9 M, from about 0.6 M to about 1 M, from about 0.7 M to about 0.8 M, from about 0.7 M to about 0.9 M, from about 0.7 M to about 1 M, from about 0.8 M to about 0.9 M, from about 0.8 M to about 1 M, and from about 0.9 M to about 1 M.

In some aspects, the solution can include a first solvent. In some aspects, the solution can include a second solvent. In some aspects, the first solvent and the second solvent can have a ratio. In some aspects, the ratio of the first solvent to the second solvent can be from about 2:1 to about 1:2. including exemplary values of about 2:1, about 3:2, about 1:1, about 2:3, about 1:2, or any subrange formed from the above exemplary values. In some aspects, the ratio of the first solvent to the second solvent is can be from about 2:1 to about 3:2, from about 2:1 to about 1:1, from about 2:1 to about 2:3, from about 2:1 to about 1:2, from about 3:2 to about 1:1, from about 3:2 to about 2:3, from about 3:2 to about 1:2, from about 1:1 to about 2:3, from about 1:1 to about 1:2, or from about 2:3 to about 1:2.

In some aspects, the first solvent and the second solvent can reduce a solvation number of the intercalating electrolyte compared to a solvation number of the intercalating electrolyte in the first solvent or the second solvent alone.

In some aspects, the first solvent can include dimethyl sulfoxide. In some aspects, the cation of the intercalating electrolyte can form a complex with DMSO, said complex intercalating into the interlayer spacing. In some aspects, the cation is lithium, wherein lithium of the intercalating electrolyte can form a complex with DMSO, said complex intercalating into the interlayer spacing. In some aspects, the intercalating electrolyte can include lithium perchlorate.

In some aspects, the second solvent can include dimethyl carbonate.

In some aspects, the reactor can include a working electrode. In some aspects, the working electrode can be a cathode. In some aspects, the working electrode includes the graphite. In some aspects, the graphite included in the working electrode can be in contact with the solution. In some aspects, the graphite at the working electrode can be in the form of a foil, rod, powder, or sheet. In some aspects, the graphite at the working electrode can be highly oriented pyrolytic graphite (HOPG).

In some aspects, the reactor can include a counter electrode. In some aspects, the counter electrode can be an anode. Representative examples of suitable anodes include, but are not limited to, platinum foil, a graphite rod or foil, and lithium foil. In some aspects, the anode can be an impressed current anode. In some aspects, the counter electrode can be in contact with the solution.

In another aspect, a plurality of graphene sheets is provided produced by a method as described herein.

In another aspect, an article or device is provided including a plurality of graphene sheets produced by a method described herein. Representative examples of articles and devices that can include graphene sheets as produced herein include, but are not limited to, electronics and displays (such as touchscreens, LCDs, OLED panels, flexible display screens, high-speed transistors, and photonic devices), sensors and medical devices (such as chemical and biosensors, wearable biosensors, and point-of-care diagnostic devices), energy storage and conversion devices (such as batteries and solar panels), composites and structural materials (such as additive manufactured structural parts and coatings), biomedical articles and devices (such as drug or gene delivery systems, antimicrobial surfaces, and tissue engineering scaffolds), conductive inks, automotive parts, tires, construction materials, thermal management components (such as electronic heat sinks), neuroprosthetics, packaging, and the like.

In some aspects, the article or device can be an electrode. In some aspects, the electrode can include graphene sheets as used herein in any one or more components of the electrode for which the graphene sheets are suitable. In some aspects, the graphene sheets can be a coating or an

In some aspects, the electrode can be an anode. In some aspects, the graphene sheets as used herein can be used Any known in the art anode materials can be present. For example, and without limitations, the anode electrode includes one or more metallic alkali and/or alkaline earth foils, alkali and/or alkaline earth powder, alkali and/or alkaline earth meshes, alkali and/or alkaline earth alloys, carbon materials, non-alkali and/or non-alkaline earth metal alloys, nonmetal alloys, compound materials, or any combination thereof. Yet in still further aspects, the anode electrode includes Li metal, Li metal alloy, lithium titanium oxide, titanium niobium oxide, silicon alloy, silicon tin alloy, tin, aluminum, carbon, graphite, carbonaceous anodes, or any combination thereof.

In some aspects, the electrode can be a cathode. Any known in the art cathodes can be used. For example, and without limitations, the cathode electrode can include one or more layered oxides, spinel oxides, olivines, polyanion-based cathodes, Prussian Blue analogs, Prussian White analogs, sulfur-based cathodes, selenium-based cathodes, vanadium-based cathodes, sulfide-based cathodes, or any combination thereof.

In some aspects, the article or device can be an electrochemical cell. In some aspects, the electrochemical cell can include graphene sheets as used herein in any one or more components of the electrochemical cell for which the graphene sheets are suitable.

In another aspect, an electrochemical cell is provided. The electrochemical cell includes an electrode and an electrolyte. In some aspects, the electrode can be an electrode as described herein, i.e., an electrode including graphene sheets produced according to the method described herein. In some aspects, the graphene sheets can be a coating, binder, or additive within the electrode. In other aspects, the electrode does not include graphene sheets as produced herein. In some aspects, the electrode can be an anode. In other aspects, the electrode can be a cathode. In aspects where the electrode is an anode, the electrochemical cell may optionally further include a cathode electrode. In aspects where the electrode is a cathode, the electrochemical cell may optionally further include an anode electrode.

For the optionally further included anode electrode of the electrochemical cells described herein, any known in the art anode materials can be present. For example, and without limitations, the anode electrode includes one or more metallic alkali and/or alkaline earth foils, alkali and/or alkaline earth powder, alkali and/or alkaline earth meshes, alkali and/or alkaline earth alloys, carbon materials, non-alkali and/or non-alkaline earth metal alloys, nonmetal alloys, compound materials, or any combination thereof. Yet in still further aspects, the anode electrode includes Li metal, Li metal alloy, lithium titanium oxide, titanium niobium oxide, silicon alloy, silicon tin alloy, tin, aluminum, carbon, graphite, carbonaceous anodes, or any combination thereof. Yet in still further aspects, the electrochemical cell can be “anodeless.” In such aspects, the anode electrode is a current collector for an alkali metal or alkaline earth metal deposition during a plating step. In such aspects, the current collectors can be a metal or another conductive material, such as (but not limited to) nickel (Ni), copper (Cu), aluminum (Al), iron (Fe), stainless steel, or conductive carbon materials. The current collector may be a foil, a foam, or a polymer substrate coated with a conductive material.

For the optionally further included cathode electrode of the electrochemical cells described herein, any known in the art cathodes can be used. For example, and without limitations, the cathode electrode can include one or more layered oxides, spinel oxides, olivines, polyanion-based cathodes, Prussian Blue analogs, Prussian White analogs, sulfur-based cathodes, selenium-based cathodes, vanadium-based cathodes, or any combination thereof. In yet still further aspects, the cathodes are sulfide-based cathodes.

In still further aspects, the electrolyte is a liquid electrolyte including a salt and a solvent. In such aspects, the salt can include one or more of a lithium, sodium, or potassium salt of fluorophosphate (e.g., LiPF₆, NaPF₆, KPF₆), fluoroborate (e.g., LiBF₄, NaBF₄, KBF₄), tetraphenylborate (e.g., LiBPh₄, NaBPh₄, KBPh₄), bis(fluorosulfonyl)imide (e.g., LiFSI, NaFSI, KFSI), bis(trifluoromethanesulfonyl)imide (e.g., LiTFSI, NaTFSI, KTFSI), (fluorosulfonyl)(trifluoromethanesulfonyl)imide (e.g., LiFTFSI, NaFTFSI, KFTFSI), perchlorate (e.g., LiClO₄, NaClO₄, KClO₄), nitrate (e.g., LiNO₃, NaNO₃, KNO₃), 4,5-dicyano-2-(trifluoromethyl)imidazole (e.g., LiTDI, NaTDI, KTDI), 4,5-dicyano-2-(pentafluoromethyl)imidazole (e.g., LiPDI, NaPDI, KPDI), and difluorooxalatoborate (e.g., LiDFOB, NaDFOB, KDFOB), or any combination thereof.

In yet further aspects, the solvent includes one or more of ethylene carbonate (EC), 1,2-dimethoxyethane (DME), propylene carbonate (PC), dimethyl carbonate (DMC), diethyl carbonate (DEC), 1,2-dimethoxyethane (DME), fluoroethylene carbonate (FEC), tetrahydrofuran (THF), diethylene glycol dimethyl ether (diglyme), triethylene glycol dimethyl ether (TDEM), tetraethylene glycol dimethyl ether (TEGDME), and vinylene carbonate (VC), bis(2,2,2-trifluoroethyl) ether (BTFE), 1,1,2,2-tetrafluoroethyl 2,2,3,3-tetrafluoropropylether (TTE), tris(2,2,2-trilfuoroethyl) orthoformate (TFEO), trimethylphosphate (TMP), triethylphosphate (TEP), methyl acetate, propionate, butyrate, or any combination thereof. It is understood that the electrolyte can include one solvent or a mixture of two or more solvents. If more than one solvent is present, such solvents can be in any weight or volume ratio relative to each other.

In still further aspects, the salt can be present in the electrolyte in any amount that provides the desired conductivity and can be dictated by the solubility of the salt in a specific solvent. In certain aspects, the salt is present in an amount of 0.01 M to 3 M, including exemplary values of 0.05 M, 0.1 M, 0.2 M, 0.3 M, 0.4 M, 0.5 M, 0.6 M, 0.7 M, 0.8 M, 0.9 M, 1 M, 1.1 M, 1.2 M, 1.3 M, 1.4 M, 1.5 M, 1.6 M, 1.7 M, 1.8 M, 1.9 M, 2 M, 2.1 M, 2.2 M, 2.3 M, 2.4 M, 2.5 M, 2.6 M, 2.7 M, 2.8 M, and 2.9 M. In still further aspects, the salt can be present in any amount between any two foregoing values. In yet still further aspects, the sale can be present in an amount that falls within a range formed by any two values described above. For example, the salt can be present in an is amount of 0.05 M to 3 M, 0.1 M to 3 M, 0.5 M to 3 M, 1 M to 3 M, about 1.5 M to 3 M, 2 M to 3 M, and so on. It is understood, however, that in certain aspects, when the solubility of the salt allows it, the salt can be present in an amount higher than 3 M, higher than 3.5 M, higher than 4 M, higher than 4.5 M, or even higher than 5 M.

In still further aspects, it is understood that the salt amount can be presented in different units, such as molality or weight (wt) %. In aspects where the salt amount is presented in wt %, the weight percent of the salt is calculated based on the total weight of the electrolyte.

Yet also disclosed herein are aspects where the electrolyte is a solid electrolyte. In still further aspects, the battery can include any solid or hybrid electrolyte known in the art. In certain aspects, the electrolyte is a solid electrolyte and includes an inorganic ceramic/glass-ceramic, organic polymer, and ceramic-polymer composite electrolytes. For example, and without limitations, the solid electrolyte can include doped and undoped LISICON-type compounds, perovskite-type and anti-perovskite-type compounds, nitrides, oxynitrides, beta-alumina, Cryolite-type, argyrodite-type, or polymer-based electrolytes, or ceramic-polymer composite electrolytes, or any combination thereof. If the electrolyte includes polymer-based electrolytes, such electrolytes can further include an alkali metal, an alkaline-earth metal salt, or a combination thereof.

In still further aspects, where electrochemical cells include a liquid electrolyte, for example, the electrochemical cell can further include a separator. In some aspects, the separator can include graphene sheets as prepared according to the method described herein. In such aspects, any known in the art separators that are capable of achieving the desired results can be used. For example, and without limitations, the separators can include glass fiber, a porous polymer film (e.g., polyethylene- or polypropylene-based material) with or without a ceramic coating, or a composite (e.g., a porous film of inorganic particles and a binder). One exemplary polymeric separator is a polyethylene (PE) membrane. Another exemplary polymeric separator is a polypropylene (PP) membrane. The separator may be infused with any of the disclosed herein electrolytes.

In still further aspects, the electrochemical cell can operate at a voltage of 2.0 V to 4.4 V, including exemplary values of 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, and 4.3 V. In still further aspects, the is battery can operate at any voltage that falls between any two foregoing values or within the range formed by any two foregoing values. For example, the electrochemical cell can operate at a voltage of 2.0 V to 4.5 V, 2.0 V to 4.3 V, 2.0 V to 3.5 V, 2.0 to 3.0 V, 2.5 V to 4.3 V, 2.5 V to 4 V, 2.5 V to 3.5 V, 2.5 V to 3 V, 3 V to 4.4V, 3.5 V to 4.4 V, 4 V to 4.4 V, 3.6 V to 4.3 V, 3.6 V to 4 V, 3.6 V to 3.8 V, and so on.

In still further aspects, the electrochemical cell disclosed herein can exhibit a capacity retention of at least 75% over at least 200 cycles. Yet in still further aspects, the electrochemical cell disclosed herein can exhibit capacity retention of at least 75% over at least 500 cycles. In yet still further aspects, the electrochemical cell exhibits a capacity retention of at least 75%, at least 80%, at least 85%, at least 90%, at least 95%, and at least 99% over at least 500 cycles. It is understood that such capacity retention can also be observed for at least 700 cycles, at least 1,000 cycles, at least 5,000 cycles, at least 10,000 cycles, or at least 20,000 cycles.

In still further aspects, the electrochemical cells disclosed herein can exhibit a Coulombic efficiency greater than 80%, greater than 85%, greater than 90%, greater than 95%, or greater than 99% over at least 500 cycles. It is understood that such Coulombic efficiency can also be observed for at least 700 cycles, at least 1,000 cycles, at least 5,000 cycles, at least 10,000 cycles, or at least 20,000 cycles.

In still further aspects, the electrochemical cells disclosed herein are capable of operating in a temperature range from −30° C. to 60° C., including exemplary values of −25° C., −20° C., −15° C., −10° C., −5° C., 0° C., t 5° C., 10° C., 15° C., 20° C., 25° C., 30° C., 35° C., 40° C., 45° C., 50° C., and 55° C. It is further understood that the electrochemical cells can operate at any value that falls between any foregoing values on in any range or in any range that is formed by the disclosed values. For example, the electrochemical cells disclosed herein are capable of operating in a temperature range from −25° C. to 60° C., −10° C. to 60° C., 0° C. to 60° C., 10° C. to 60° C., 20° C. to 60° C., 30° C. to 60° C., or 40° C. to 60° C., or −30° C. to 50° C., −30° C. to 40° C., −30° C. to 30° C., −30° C. to 20° C., −30° C. to 10° C., t −30° C. to 0° C., and so on.

In still further aspects, the electrochemical cells disclosed herein exhibit a specific capacity of 100 mAh g⁻¹ to 400 mAh g⁻¹ at a discharge rate of at least 0.1 C. For example, the electrochemical cell can exhibit a specific capacity of 100 mAh g⁻¹ to 400 mAh g⁻¹, including exemplary values of 110 mAh g⁻¹, 120 mAh g⁻¹, 145 mAh g⁻¹, 150 mAh g⁻¹, 200 mAh g⁻¹, 250 mAh g⁻¹, 300 mAh g⁻¹, and 350 mAh g⁻¹, at a discharge rate of at least 0.1 C, of at least 0.2 C, of at least 0.5 C, of at least 1 C, of at least 2 C, of at least 3 C, of at least 4 C, of at least 5 C, and so on. It is understood that the specific capacity can fall between any disclosed above values or can fall within any range formed by the disclosed above values. In certain aspects, the electrochemical cells disclosed herein exhibit a specific capacity of 100 mAh g⁻¹ to 400 mAh g⁻¹, 145 mAh g⁻¹ to 400 mAh g⁻¹, 200 mAh g⁻¹ to 400 mAh g⁻¹, 300 mAh g⁻¹ to 400 mAh g⁻¹, 100 mAh g⁻¹ to 350 mAh g⁻¹, 100 mAh g⁻¹ to 300 mAh g⁻¹, 100 mAh g⁻¹ to 250 mAh g⁻¹, 100 mAh g⁻¹ to 200 mAh g⁻¹, 110 mAh g⁻¹ to 190 mAh g⁻¹, 120 mAh g⁻¹ to 180 mAh g⁻¹, 130 mAh g⁻¹ to 170 mAh g⁻¹, 140 mAh g⁻¹ to 160 mAh g⁻¹, and so on at any of the disclosed above discharge rates.

In another aspect, a battery is provided including one or more electrochemical cells as described herein. In some aspects, the battery is a primary battery. In other aspects, the battery is a secondary battery. In some aspects, the battery can be a lithium-ion battery, sodium-ion battery, lithium-sulfur battery, sodium-sulfur battery, or other type of battery.

By way of example, the batteries of the present disclosure may be used in portable batteries, including those in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicle, such as a boat, submarine, bus, train, truck, car, motorcycle, moped, powered bicycle, airplane, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, according to the present disclosure, the batteries can be multi-cell batteries containing at least 10, at least 100, at least 500, between 10 and 10,000, between 100 and 10,000, between 1,000 and 10,000, between 10 and 1000, between 100 and 1,000, or between 500 and 1,000 individual electrochemical cells of the present disclosure. Cells in multi-cell batteries may be arranged in parallel or in series.

In view of the described compositions, articles, devices, and methods, certain more particular aspects of the disclosure are described below. These particularly recited aspects should not, however, be interpreted to have any limiting effect on any different claims containing different or more general teachings described herein, or that the “particular” aspects are somehow limited in some way other than the inherent meanings of the language and formulae literally used therein.

Aspect 1. A method of producing isolated graphene sheets from graphite,
wherein the graphite contains therein hexagonal carbon atomic interlayers with an interlayer spacing,
the method comprising:
   (a) forming an intercalated graphite compound by an electrochemical intercalation procedure conducted in an electrochemical reactor,
   wherein the reactor comprises:
      (i) a solution comprising an intercalating electrolyte, a first solvent, and a second solvent;
      (ii) a working electrode comprising the graphite in contact with the solution; and
      (iii) a counter electrode in contact with the solution;
   wherein a current is imposed to effect electrochemical intercalation of the intercalating electrolyte into the interlayer spacing; and
   (b) exfoliating and separating the hexagonal carbon atomic interlayers from the intercalated graphite compound to produce the isolated graphene sheets.

Aspect 2. The method of any aspect herein, such as aspect 1, wherein the isolated graphene sheets comprise single-layer graphene sheets.

Aspect 3. The method of any aspect herein, such as aspect 1 or aspect 2, wherein the isolated graphene sheets comprise few-layer graphene sheets comprising from about 2 to about 10 layers.

Aspect 4. The method of any aspect herein, such as any one of aspects 1-3, wherein the first solvent and the second solvent are present in a ratio of about 1:2 of the first solvent to the second solvent.

Aspect 5. The method of any aspect herein, such as any one of aspects 1-4, wherein the first solvent comprises dimethyl sulfoxide (DMSO).

Aspect 6. The method of any aspect herein, such as any one of aspects 1-5, wherein the intercalating electrolyte includes a cation selected from an alkali metal cation, a magnesium cation, or a quaternary ammonium cation.

Aspect 7. The method of any aspect herein, such as any one of aspects 1-6, wherein intercalating electrolyte includes a lithium cation, a sodium cation, a potassium cation, a magnesium cation, a tetramethylammonium cation, a tetraethylammonium cation, a tetrabutyl ammonium cation, or a tetraheptylammonium cation.

Aspect 8. The method of any aspect herein, such as any one of aspects 1-7, wherein the intercalating electrolyte comprises a lithium ion.

Aspect 9. The method of any aspect herein, such any one of aspects 6-8, wherein the cation forms a complex with DMSO, and said complex intercalates into the interlayer spacing.

Aspect 10. The method of any aspect herein, such as any one of aspects 1-9, wherein the intercalating electrolyte includes an anion selected from a chloride anion, a bromide anion, a perchlorate anion, a sulfate anion, a nitrate anion, or a hydroxide anion.

Aspect 11. The method of any aspect herein, such as aspect 10, wherein the intercalating electrolyte includes a perchlorate anion.

Aspect 12. The method of any aspect herein, such as any one of aspects 1-11, wherein the intercalating electrolyte comprises lithium perchlorate.

Aspect 13. The method of any aspect herein, such as any one of aspects 1-12, wherein the intercalating electrolyte has a concentration in the solution from about 0.1 M to about 1 M.

Aspect 14. The method of any aspect herein, such as any one of aspects 1-13, wherein the second solvent comprises dimethyl carbonate (DMC).

Aspect 15. The method of any aspect herein, such as any one of aspects 1-14, wherein the first solvent and the second solvent can reduce a solvation number of the intercalating electrolyte compared to a solvation number of the intercalating electrolyte in the first solvent or the second solvent alone.

Aspect 16. The method of any aspect herein, such as any one of aspects 1-15, wherein the working electrode is a cathode.

Aspect 17. The method of any aspect herein, such as any one of aspects 1-16, wherein the graphite included at the working electrode is in the form of a foil, rod, powder, or sheet.

Aspect 18. The method of any aspect herein, such as any one of aspects 1-17, wherein the counter electrode is an anode.

Aspect 19. The method of any aspect herein, such as aspect 18, wherein the anode is platinum foil, a graphite rod or foil, or lithium foil.

Aspect 20. The method of any aspect herein, such as any one of aspects 1-19, wherein the current is a direct current.

Aspect 21. The method of any aspect herein, such as any one of aspects 1-20, wherein electrochemical intercalation can occur at a voltage from about −5 V to about −10V.

Aspect 22. A plurality of graphene sheets produced by a method of any aspect herein, such as any one of aspects 1-21.

Aspect 23. An article or device comprising a plurality of graphene sheets of any aspect herein, such as aspect 22.

Aspect 24. The article or device of any aspect herein, such as aspect 23, wherein the device comprises an electrode, an electrochemical cell, or a battery.

Aspect 25. The article or device of any aspect herein, such as aspect 24, wherein the device comprises a lithium ion battery.

Aspect 26. An electrochemical intercalation reactor comprising:
(i) a solution comprising an intercalating electrolyte, a first solvent, and a second solvent;
(ii) a working electrode comprising graphite in contact with the solution; and
(iii) a counter electrode in contact with the solution.

Aspect 27. The reactor of any aspect herein, such as aspect 26, wherein the first solvent and the second solvent are present in a ratio of about 1:2 of the first solvent to the second solvent.

Aspect 28. The reactor of any aspect herein, such as aspect 26 or aspect 27, wherein the first solvent comprises dimethyl sulfoxide (DMSO).

Aspect 29. The reactor of any aspect herein, such as any one of aspects 26-28, wherein the intercalating electrolyte includes a cation selected from an alkali metal cation, a magnesium cation, or a quaternary ammonium cation.

Aspect 30. The reactor of any aspect herein, such as any one of aspects 26-29, wherein intercalating electrolyte includes a cation selected from lithium cation, a sodium cation, a potassium cation, a magnesium cation, a tetramethylammonium cation, a tetraethylammonium cation, a tetrabutyl ammonium cation, or a tetraheptylammonium cation.

Aspect 31. The reactor of any aspect herein, such as any one of aspects 26-30, wherein the intercalating electrolyte comprises a lithium cation.

Aspect 32. The reactor of any aspect herein such as any one of aspects 29-31, wherein the cation forms a complex with DMSO, and said complex intercalates into the interlayer spacing.

Aspect 33. The reactor of any aspect herein, such as any one of aspects 26-32, wherein the intercalating electrolyte includes an anion selected from a chloride anion, a bromide anion, a perchlorate anion, a sulfate anion, a nitrate anion, or a hydroxide anion.

Aspect 34. The reactor of any aspect herein, such as any one of aspects 26-33, wherein the intercalating electrolyte includes a perchlorate anion.

Aspect 35. The reactor of any aspect herein, such as any one of aspects 26-34, wherein the intercalating electrolyte comprises lithium perchlorate.

Aspect 36. The reactor of any aspect herein, such as any one of aspects 26-35, wherein the intercalating electrolyte has a concentration in the solution from about 0.1 M to about 1 M.

Aspect 37. The reactor of any aspect herein, such as any one of aspects 26-36, wherein the second solvent comprises dimethyl carbonate (DMC).

Aspect 38. The reactor of any aspect herein, such as any one of aspects 26-37, wherein the working electrode is a cathode.

Aspect 39. The reactor of any aspect herein, such as any one of aspects 26-38, wherein the graphite included at the working electrode is in the form of a foil, rod, powder, or sheet.

Aspect 40. The reactor of any aspect herein, such as any one of aspects 26-39, wherein the counter electrode is an anode.

Aspect 41. The reactor of any aspect herein, such as any one of aspects 26-40, wherein the anode is platinum foil, a graphite rod or foil, or lithium foil.

A number of aspects of the disclosure have been described. Nevertheless, it will be understood that various modifications may be made without departing from the spirit and scope of the disclosure. Accordingly, other aspects are within the scope of the following claims.

By way of non-limiting illustration, examples of certain aspects of the present disclosure are given below.

### EXAMPLES

The following examples are set forth below to illustrate the compositions, articles, devices, and methods claimed herein, along with associated methods and results according to the disclosed subject matter. These examples are not intended to be inclusive of all aspects of the subject matter disclosed herein, but rather to illustrate representative methods and results. These examples are not intended to exclude equivalents and variations of the present disclosure, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1. Few-Layered Graphene from Cathodic Exfoliation in Binary Solvents and Application as a Protective Layer for Lithium Metal Anodes

Electrochemical exfoliation is a top-down method recognized for its environmentally friendly and scalable approach for producing solution-processable graphene. Among its variation, cathodic exfoliation stands out for its potential in generating few-layer graphene with minimal defects. In this example, we developed a cathodic exfoliation method for graphite foil using a binary solvent system to produce graphene with a reduced number of layers. By employing a 0.1 M LiClO₄ solution in a dimethyl sulfoxide and dimethyl carbonate solvents mixture at a 1:2 volume ratio, we enhanced the intercalation of solvated lithium ions into graphite, successfully exfoliating graphene with 5-6 layers. The exfoliated graphene exhibited a low defect density (ID/IG ˜0.05) and a C/O ratio of 33.2. Furthermore, when used as a coating on a separator, the exfoliated few-layered graphene (FLG) sheets demonstrated notable performance as a protective layer for Li metal anode in Li metal battery technology.

Graphene is a single layer of carbon atoms arranged in a hexagonal lattice. The combination of strong C—C bonds, sp² hybridization, and a two-dimensional structure gives graphene its unique properties, such as high electrical conductivity, mechanical strength, and thermal conductivity. In 2004, Novoselov and Geim first isolated free-standing graphene by micromechanical exfoliation from graphite using Scotch tape.³ Since then, many researchers have studied the intrinsic properties and potential applications of graphene, such as electronics, sensors, and energy storage devices. The production of graphene at low cost, high yield, and high quality has become a significant focus in recent years to meet the growing demand for graphene in various industries. Graphene production methods fall into two main categories: bottom-up and top-down approaches. Bottom-up approaches involve synthesizing graphene from small molecules or atoms, such as chemical vapor deposition or epitaxial growth, which offer high control over graphene's structure and purity. On the other hand, top-down approaches focus on breaking down bulk graphite into graphene layers. Chemical exfoliation methods, an example of top-down approaches, typically involve oxidizing and subsequently reducing graphite to obtain reduced graphene oxide. However, the chemical method of graphene production often results in the incorporation of oxygen functional groups and defects into the graphene structure, limiting its potential use in certain applications that require high-quality graphene.

Electrochemical exfoliation methods provide a promising alternative to chemical methods, as they can offer controlled exfoliation without introducing significant defects or functional groups. Particularly, the cathodic electrochemical exfoliation method has demonstrated promise in producing graphene with improved structural integrity. The electrochemical exfoliation process involves applying an electrical potential to graphite in an appropriate electrolyte solution. In anodic exfoliation, a positive potential oxidizes graphite, leading to the formation of graphene oxide. Conversely, cathodic electrochemical exfoliation occurs in reducing environments, leading to the production of graphene with fewer defects and functional groups. This makes it ideal for specific applications that demand high-quality graphene. However, the efficiency of cathodic exfoliation is hindered by the insufficient intercalation of large cations or solvated ions, which can cause graphite to fragment into large flakes. This issue is particularly notable in electrolytes containing lithium (Li) or alkylammonium ions in organic solvents. In 2011, Loh et al. first reported the destructive behavior during the co-intercalation of Li⁺/propylene carbonate (PC) complexes into graphite, which result in the production of few-layered graphene (FLG) flakes after extended sonication times of over 10 hr. Subsequently, Dryfe et al. introduced a single-stage exfoliation method using the intercalation of larger tetraalkylammonium cations, eliminating the need for the sonication process. However, the exfoliation efficiency of this method is limited because large cations or solvated ions tend to fragment graphite into thick pieces. Many graphite fragments do not undergo sufficient intercalation during these processes, and prolonged sonication further reduces graphene size, but these issues can be mitigated by enhancing cation intercalation.

Li metal batteries (LMBs) represent a promising advancement in rechargeable battery technology by using Li metal as the anode instead of the traditional graphite anode. This substitution offers a considerable increase in energy density and significant potential for enhanced energy storage. However, the practical implementation of LMBs faces several obstacles, including the formation of Li dendrites, volume expansion, and low Coulombic efficiency (CE) during cycling. Li dendrites can create short circuits and pose a risk of thermal runaway when they puncture the separator. To address these challenges, extensive research has been conducted to develop various protective layers for Li metal anodes. One promising approach involves coating the Li metal anode (LMA) with few-layered graphene, which can significantly reduce dendrite formation and improve cycling stability. Li atoms depositing on graphene substrates grow along the (110) crystallographic plane due to lattice matching between Li and the graphene substrate. This guided growth results in planar and smooth Li layers, avoiding dendritic formation. Additionally, graphene's flexibility accommodates the anode's volume changes, thereby minimizing mechanical stress and preventing electrode cracking. However, there has been little interest in employing high-quality graphene produced by cathodic exfoliation as a protective layer for LMA. We envisioned that cathodically produced structure-controlled graphene can provide excellent mechanical strength, chemical stability, and uniform coverage, all of which are essential for enhancing the protective properties of the graphene layer for LMBs.

In this example, we developed a cathodic exfoliation system using binary solvents as electrolytes to enhance Li ion intercalation into graphite structure by reducing the solvation number of Li, producing FLG with 15 minutes of sonication post-process. The use of a binary solvent system in cathodic electrochemical exfoliation shows promising results in improving exfoliation efficiency and producing high-quality graphene with few layers. In-situ mass spectroscopy suggests that graphite exfoliation occurs with gas evolution from electrolyte decomposition. In addition, the feasibility of electrochemically exfoliated graphene in binary solvents (EGBS) as a protective layer for LMA is demonstrated for practical energy storage applications. Full cells with 35 μm thick Li anode, an EGBS-coated separator, and a LiFePO₄ (LFP) cathode deliver excellent capacity retention of 88% with an average CE of 99.9% after 400 cycles at a high current density of 3 mA cm⁻². This approach highlights the potential of high-quality, cathodically exfoliated graphene for enhancing the protective properties of the graphene layer and ensuring the long-term durability and performance of LMBs.

### Methods

Graphite exfoliation in binary solvents: Graphite foil (0.013 cm thickness, Alfa Aesar) was cut into 2 cm×1 cm pieces and used without further treatment. The electrolyte components included lithium perchlorate (LiClO₄), dimethyl sulfoxide (DMSO), and/or dimethyl carbonate (DMC), all purchased from Sigma Aldrich. A mass spectrometer (Cirrus 2, MKS Instruments) was connected in series with the electrochemical cell. Argon gas (ultra-high purity, Airgas) was used as the carrier gas, flowing at a rate of 20 mL min⁻¹, controlled by a mass flow controller (G-series, MKS Instruments). Before initiating the electrochemical exfoliation, the carrier gas was introduced for 2 hr to stabilize the signal on the gas analyzer. A voltage of −20 V with a compliance current of ˜1 A was applied using a source meter (Keithley 2400 Source Meter) across the electrodes for up to 1 hr. Following exfoliation, the solid products were collected and washed with deionized (DI) water, ethanol, and acetone using a vacuum filtration method, with a cellulose membrane (0.8 μm, Whatman) as the filter. After washing, the solid products were transferred to anhydrous N-methyl-pyrrole (NMP, 99.8%, Sigma-Aldrich) and subjected to sonication for 30 min.

Characterizations: The exfoliated solid products were sampled onto silicon waters by the Langmuir-Blodgett method and analyzed by scanning electron microscopy (SEM, SU8230, Hitachi) operated at 10 kV at working distance of 13 mm, transmission electron microscopy (TEM, HT7700, Hitachi) operated at 120 kV, and atomic force microscopy (AFM, Icon, Bruker). Chemical analysis of the solid products was performed using X-ray photoelectron spectroscopy (XPS, K-Alpha, Thermo Scientific) with Al Kα source and 15 W X-ray gun power, and on a spot size of 400 μm. A flood gun was used to mitigate surface charging. High-resolution Cis peaks were fitted using XPSPEAKS 4.1 software with a Shirley background and a Gaussian-Lorentzian ratio rainging from 5 to 30%. Raman spectroscopy (Qontor Dispersive Raman Spectrometer, Renishaw) was used to investigate defects in exfoliation products with a 488 nm laser, operating at 1% of Laser power and a spot size of about 1 μm.

Electrochemical analysis: EGBS dispersed in NMP solution was diluted to 0.01 mg/mL by adding additional NMP and stirring. EGBS-coated separators were prepared by vacuum filtration of the EGBS dispersed NMP solution onto a PP separator (Celgard 2500) until the EGBS loading reached 0.15 mg/cm⁻². The separators were then washed thoroughly by vacuum filtration with acetone and deionized water thoroughly, and vacuum-dried at 100° C. overnight to remove residual solvents before cell assembly. The LiFePO₄ (LFP) cathode was prepared by mixing LFP powder, super P, and PVDF with a weight ratio of 9:0.5:0.5, followed by Doctor blade coating onto Al foil. The prepared electrode was dried in a vacuum oven at 65° C. for overnight, achieving a capacity of ˜2.6 mAh cm⁻². Cell assembly was conducted in an Ar-filled glovebox (Mbraun, O₂ and H₂O<0.1 ppm) with a 2032 coin-cell configuration. EGBS-coated Celgard 2500 and 1 M LiPF₆ in ethylene carbonate (EC):diethyl carbonate (DEC) (1:1, v/v %) with fluoroethylene carbonate (FEC, 5 w/w %) were used as the separator and electrolyte, respectively. A 250 μm thick Li metal was used as the anode. The cycling performance was tested in the potential range of 2.5-4. vs. Li+/Li.

### Results and Discussions

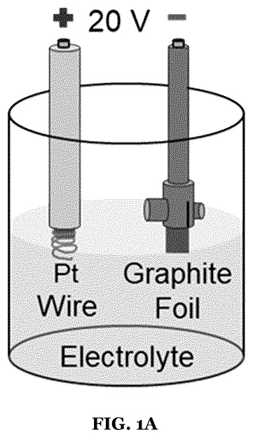

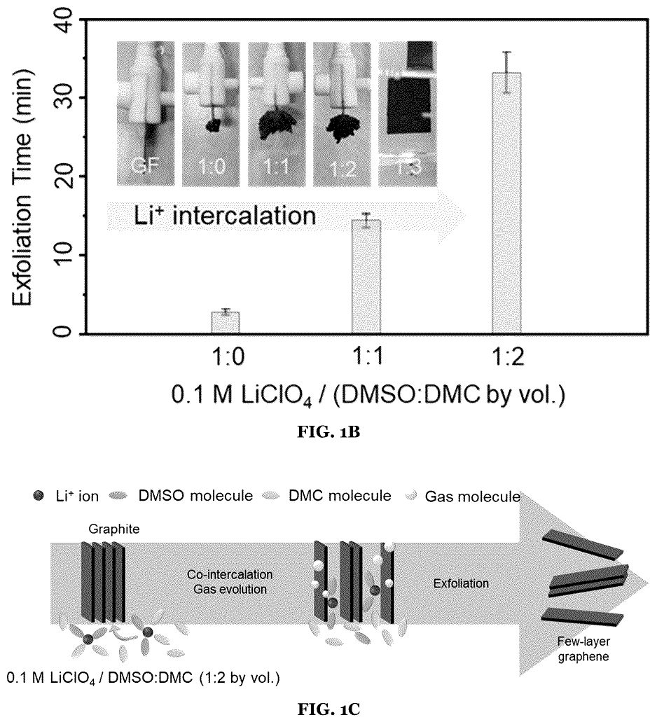

The graphite foils, cut into 1 cm×1 cm piece and prepared as-is, were immersed in 0.1 M LiClO₄ in DMSO:DMC (1:x by vol., x=0, 1, 2, and 3) as described in FIG. 1A. DMSO was selected for its wide electrochemical window and surface tension that closely matches the surface energy of graphite, thereby preventing the exfoliated graphene layers from restacking. It has been reported that the Li ions tend to combine with four DMSO molecules to form a Li+/DMSO complex, and the solvated lithium ion electrochemically intercalates into graphite structure. Yamada et al. demonstrated that reduced solvation structure of Li ions in DMSO:DMC (1:4.8 by vol) binary solutions suppress co-intercalation of DMSO and improved reversible intercalation of Li ion into graphite electrode. Raman spectroscopy allowed us to calculate the DMSO solvation number of Li ions by analyzing the intensity ratio of the Raman bands corresponding to free and solvating DMSO. The ratio of the intensities, along with the known Raman scattering intensities per unit concentration for free and solvating DMSO, allows the determination of the concentration ratio of free to solvating DMSO, which is then used to calculate the solvation number of DMSO molecules around the Li ion. Similarly, the Raman spectra of 0.1 M LiClO₄ in DMSO:DMC binary solutions showed a decrease in C—S symmetric stretch (668 cm⁻¹) from solvating molecules as more DMC solvents is added, indicating a reduced solvation number of DMSO molecules around the Li ion.

To ensure co-intercalation of Li/DMSO, electrolyte decomposition, and gas evolution for effective graphite delamination, a sufficiently low voltage of −20 V was applied to the graphite foil. As soon as the electric potential was applied, the graphite electrode expanded with gas bubbles. FIG. 1B shows the time taken for graphite delamination in a binary solvent system. The 0.1 M LiClO₄/DMSO electrolyte took about 2.5 min is to delaminate the immersed portion of graphite foil. The delamination time increases as DMC solvent is added to the mixture. The prolonged exfoliation time allows solvated Li ions sufficient time for intercalation, resulting in fewer-layered graphene flakes. In 0.1 M LiClO₄/DMSO:DMC (1:3 by vol.), the graphite foil did not delaminate but underwent significant volume expansion and the surface color turned dark blue. The color change is associated with the formation of a graphite intercalated compound (GIC), specifically corresponding to the LiC₁₈ composition.

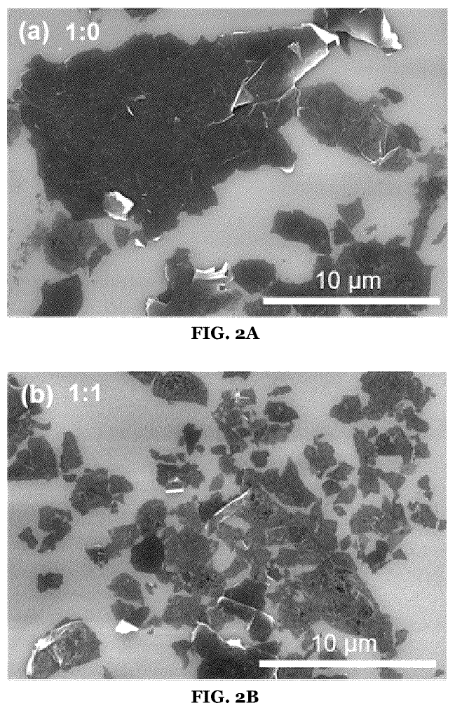

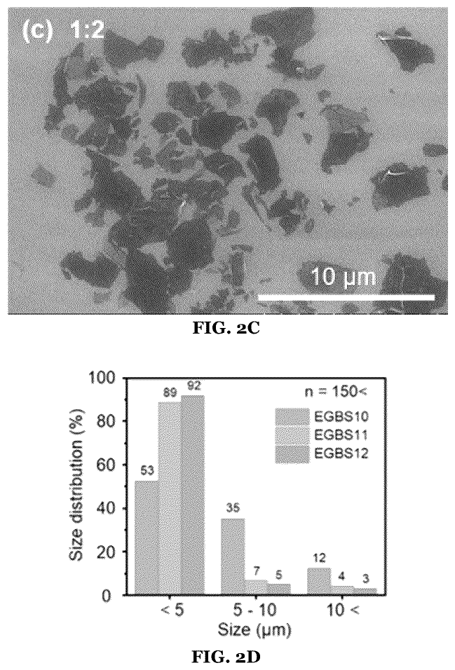

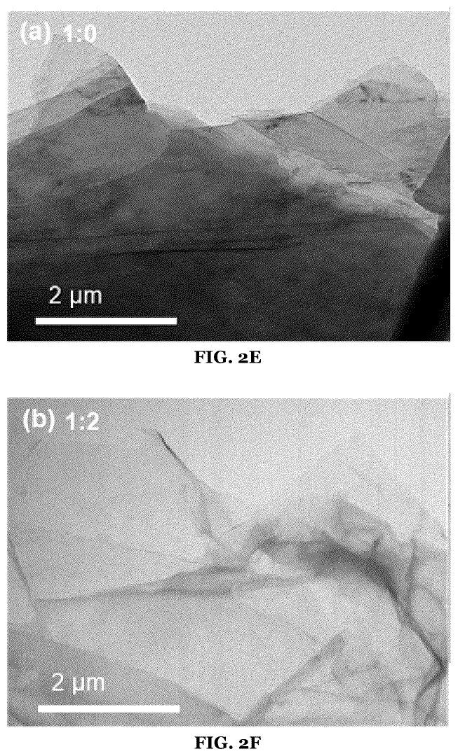

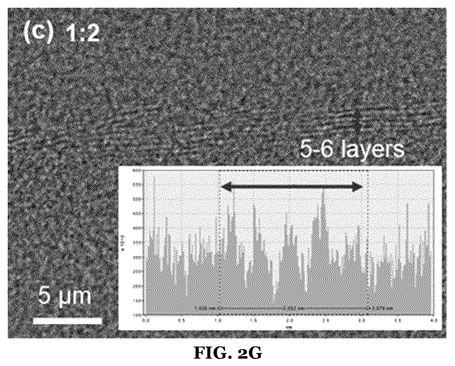

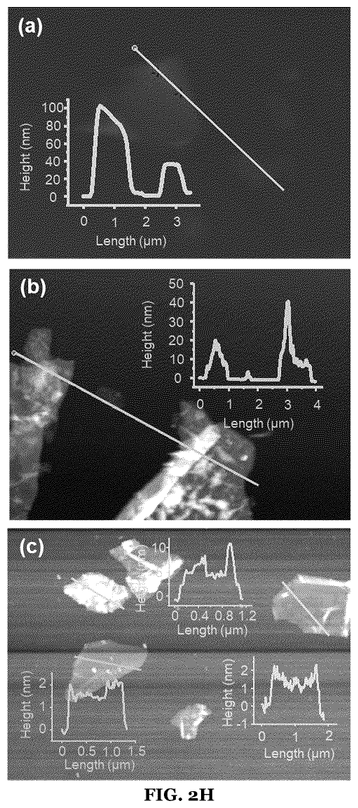

Scanning Electron Microscopy (SEM) was used to examine the size of electrochemically exfoliated graphene in 0.1 M LiClO₄ binary solvents: DMSO:DMC (1:0, 1:1, and 1:2 by vol.) (For simple notation, they are named as EGBS10, EGBS11, and EGBS12 respectively) as shown in FIGS. 2A-2C. From the statistical analysis from SEM images (FIG. 2D), a large number of EGBS10 particles were greater than 5 μm in size, with some smaller sized particles (<5 μm) observed, indicating that bulky exfoliation occurred due to vigorous electrolyte decomposition from co-intercalated DMSO solvent. As DMC solvents were added, the size of exfoliated graphene particles began to decrease. Eventually, for EGBS12, 92% of them were less than 5 μm in size, resulting in a relatively uniform exfoliation process. Transmission electron microscopy (TEM) images of EGBS10 in FIG. 2E show multiple layers of graphene flakes with stacked edges. These flakes appear darker in color than those EGBS12 in FIG. 2F under the same brightness and contrast settings of TEM. The number of layers from EGBS12 was determined to be 5-6 layers through scanning transmission electron microscopy (STEM) imaging of the edges (FIG. 2G). The collected EGBS12s samples, as shown in FIG. 2H, were measured by atomic force microscopy (AFM) to be 1.5˜2 nm in thickness. Considering the interplanar spacing of graphene stacks is 0.335 nm, the EGBS12 is about 5-6 layers as measured by STEM in FIG. 2G. About 70% of EGBS12 flakes were 2 nm thick when measured by AFM. The thickness of EGBS flakes increases with less DMC content where EGBS10 is as thick as 100 nm. The thickness of exfoliated graphene flakes can be controlled with the ratio between two solvents.

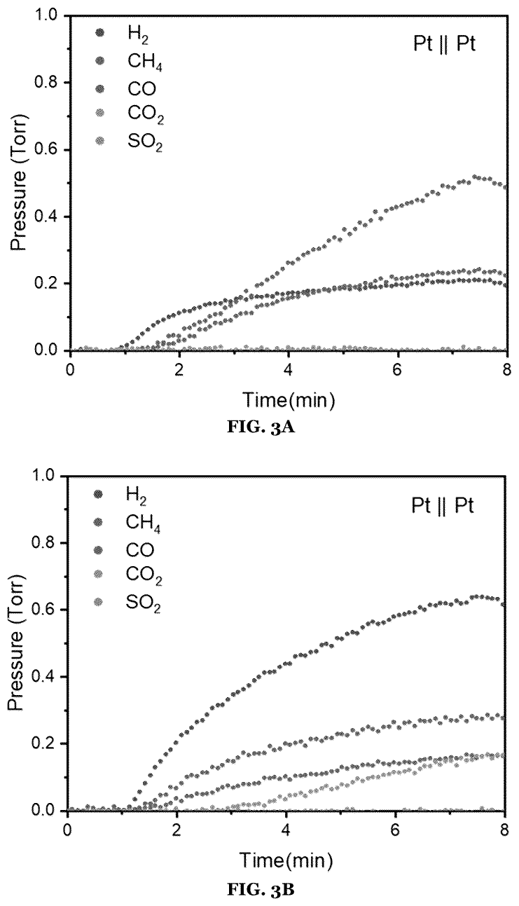

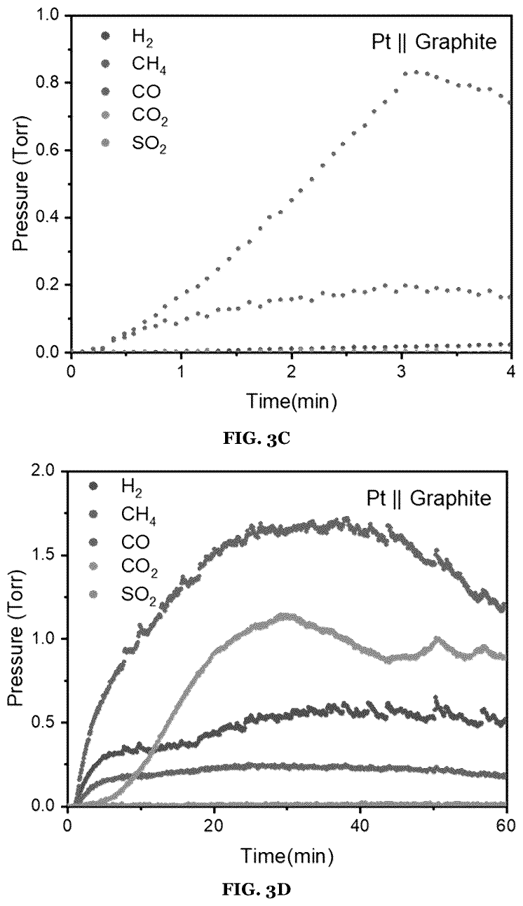

In-situ mass spectroscopy is a valuable tool for investigating the chemical reactions occurring during the electrochemical exfoliation process. Time-dependent gas spectra, converted from mass spectroscopy data collected during electrolysis with Pt and graphite electrodes under a constant voltage of −20 V, were analyzed in two is different electrolytes: 0.1 M LiClO₄/DMSO and 0.1 M LiClO₄/DMSO:DMC (1:2 by vol.). The Pt working electrodes, shown in FIGS. 3A-3B, were used to distinguish between electrolyte decomposition and chemical reactions occurring with the graphite electrode. As constant voltage was applied, mass spectrometer started to detect gaseous species from electrochemical reactions after a short delay (˜1 min). The presence of carbon monoxide (CO) and carbon dioxide (CO2) gases can be attributed to the oxidation reaction of DMSO and DMC occurring at the Pt counter electrodes. A notable increase of methane (CH₄) gas production was observed when switching from Pt to graphite electrodes (FIGS. 3C-3D) suggests that the decomposition DMSO solvent, resulting in the release of CH4 gas, is a significantly contributing to the exfoliation process.

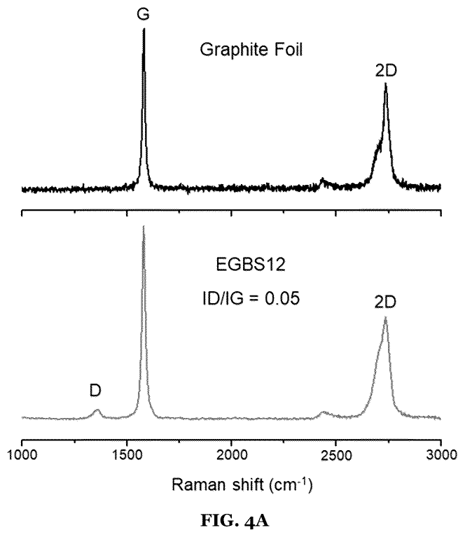

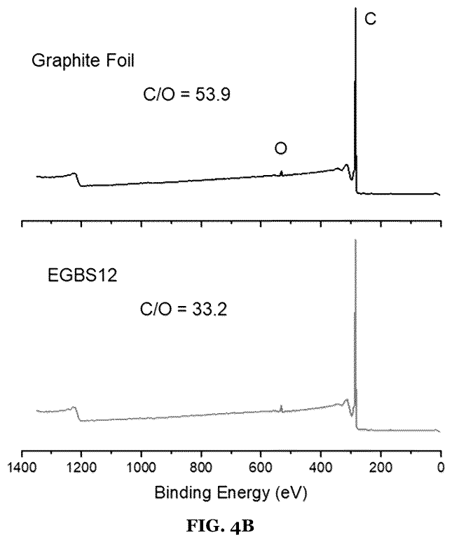

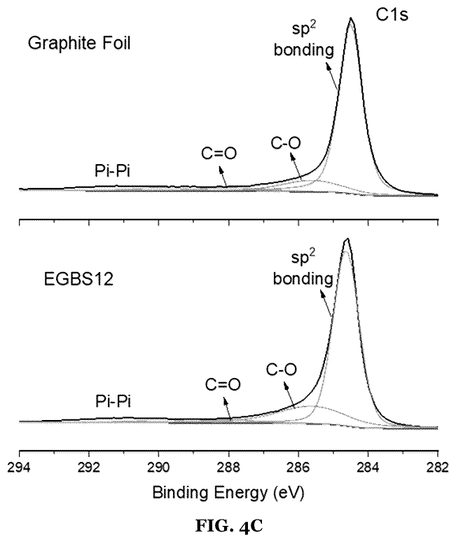

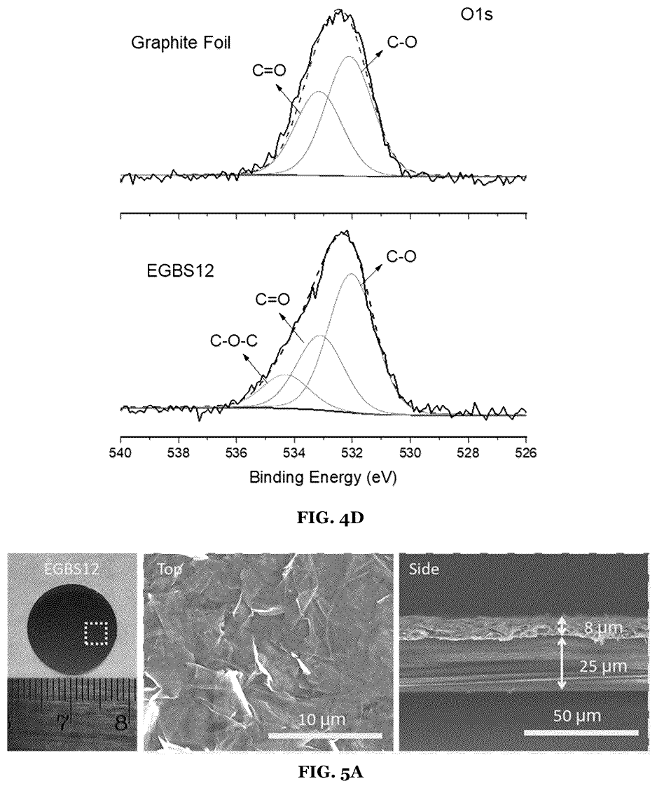

Raman spectroscopy and X-ray photoelectron spectroscopy (XPS) were conducted to investigate the structural differences of graphene products in different electrolytes. The Raman spectrum of GF in FIG. 4A shows a characteristic G band (˜1580 cm⁻¹) and a doublet of 2D bands (2D₁ at ˜2700 cm⁻¹ and 2D₂ at ˜2735 cm⁻¹). Additionally, the graphene products exhibited a broadened 2D band, which is also a hallmark of disordered carbon. The 2D bands shifted from 2683 cm⁻¹ to 2655 cm⁻¹ as DMC solvent was added to the electrolyte. The red shift of the 2D bands indicates a decrease in exfoliated graphene layers, supporting the results from the abovementioned AFM data. EGBS12 has a small D band at approximately 1350 cm⁻¹ which is related to defects and disorder in the graphene structure. The intensity ratio of D and G bands (ID/IG) provides information about the level of disorder or defects in the graphene structure. The ID/IG ratio of EGBS12 is as low as 0.05 indication of high-quality FLG flakes. The chemical composition from an XPS survey scan in FIG. 4B shows a sharp carbon peak and a small amount oxygen content in EGBS12, with a C/O ratio is 33.2. High-resolution C1s spectra (FIG. 4C) confirms the presence of sp2 bonding at 284.5 eV. The slight increase in C—O bonds, which can also be seen from high-resolution O1s in FIG. 4D, might come from DMC residue within the FLG flakes.

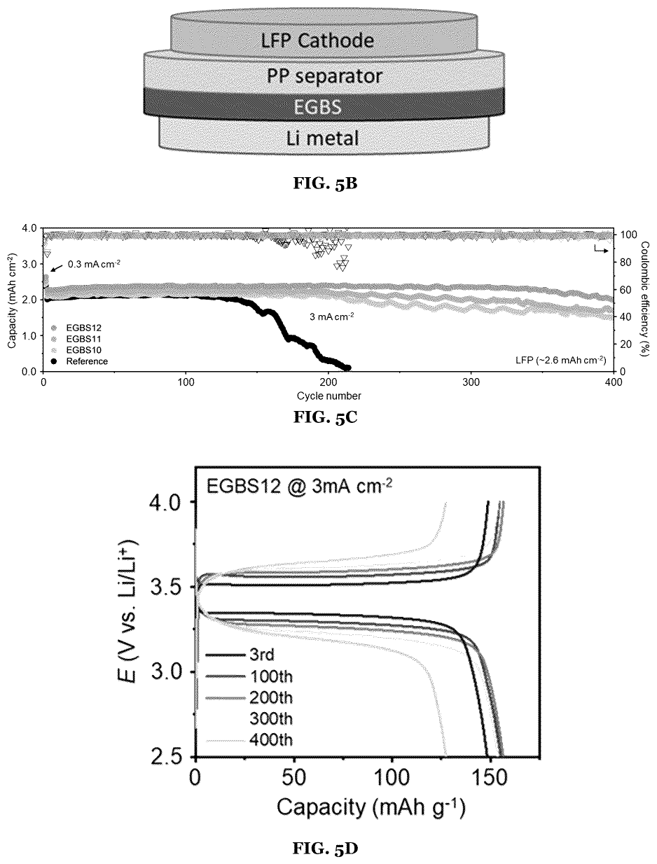

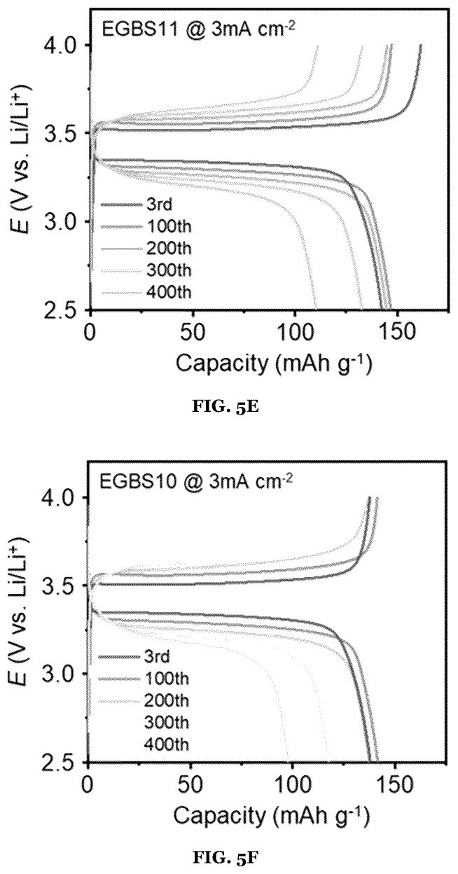

The resulting graphene dispersion in NMP solvent was vacuum filtered using a 25 μm polypropylene (PP) microporous membrane. The Raman spectra is in the 2300-3000 cm⁻¹ range, where the 2D bands appear. The graphene structures were analyzed at room temperature with a 488 nm excitation wavelength. The broad 2D bands observed suggest that all the graphene samples were multilayered, as opposed to single-layer graphene which exhibits a sharp 2D peak. Furthermore, the up-shifted 2D bands were more pronounced with an increasing number of layers. These findings confirm the height profile previously reported by AFM (FIG. 2H). The exfoliated graphene-coated separators were used to check the feasibility of exfoliated graphene as a protection layer for LMBs (FIGS. 5C-5F). Full cells with a 35 μm thick Li metal anode, a graphene-coated PP separator, and a high loading LFP cathode (2.6 mAh cm⁻²) were assembled. The cycling performance and corresponding charge/discharge profile of the full cells within the 2.5-4.0 V region were examined. The cell with EGBS12 showed remarkable cycling performance over 400 cycles at 3 mA cm⁻² with 88% capacity retention of the 3rd cycle and a high average CE of 99.9%. However, the cells of EGBS11 and EGBS10 delivered inferior stability, resulting in 77% and 71% retention rate, respectively. It is noteworthy that the cells exhibited increased capacities and stabilities with a decreasing number of graphene layers. In addition, high quality with less defective layers plays a key role in stabilizing LMA surface and effectively prevents continuous dendrite growth during cycling.

A few-layered graphene was obtained from the cathodic exfoliation of graphite in the electrolyte with binary solutions of 0.1 M LiClO₄/DMSO:DMC (1:2 by vol.). The poor exfoliation efficiency with a single DMSO solvent was improved by employing an additional DMC intercalating solvent. The solvation number of DMSO solvent around Li⁺ cation can be tuned by adjusting the ratio of two solvents. The additional DMC solvent suppresses the co-intercalation of Li⁺/DMSO into graphite by decreasing the solvation number, leading to fewer-layered graphene. The resulting EGBS, when used as a protective layer in LMBs, exhibited improved cycling performance, excellent Coulombic efficiency, and substantial Li dendrite suppression. This example highlights that high-quality graphene can significantly enhance the performance and safety of LMBs.

### References for Example 1

1. Scherrer, P., Nachrichten von der Gesellschaft der Wissenschaften zu Göttingen, Mathematisch-Physikalische Klasse. Vol. 2, 98-100.
2. Hull, A. W., A New Method of X-Ray Crystal Analysis, Physical Review 1917, 10, (6), 661-696.
3. Novoselov, K. S.; Geim, A. K.; Morozov, S. V.; Jiang, D.; Zhang, Y.; Dubonos, S. V.; Grigorieva, I. V.; Firsov, A. A. Electric field effect in atomically thin carbon films, Science 2004, 306, (5696), 666-669.
4. Papageorgiou, D. G.; Kinloch, I. A.; Young, R. J. Mechanical properties of graphene and graphene-based nanocomposites, Progress in Materials Science 2017, 90, 75-127.
5. Balandin, A. A., Thermal properties of graphene and nanostructured carbon materials, Nature materials 2011, 10, (8), 569-581.
6. Ke, Q.; Wang, J., Graphene-based materials for supercapacitor electrodes—A review, Journal of Materiomics 2016, 2, (1), 37-54.
7. Wu, J.; Pisula, W.; Müllen, K., Graphenes as Potential Material for Electronics, Chemical Reviews 2007, 107, (3), 718-747.
8. Wu, Y.; Lin, Y.-m.; Bol, A. A.; Jenkins, K. A.; Xia, F.; Farmer et al., High-frequency, scaled graphene transistors on diamond-like carbon, Nature 2011, 472, (7341), 74-78.
9. Schwierz, F., Graphene transistors, Nature Nanotechnology 2010, 5, (7), 487-496.
10. Huang, Y.; Chen, P., Nanoelectronic Biosensing of Dynamic Cellular Activities Based on Nanostructured Materials, Advanced Materials 2010, 22, (25), 2818-2823.
11. Lee, S. J.; Kim, J.-Y.; Mohd Yusoff, A. R. b.; Jang, J., Plasmonic organic solar cell employing Au NP:PEDOT:PSS doped rGO, RSC Advances 2015, 5, (30), 23892-23899.
12. Zhang, Y.; Zhang, L.; Zhou, C., Review of Chemical Vapor Deposition of Graphene and Related Applications, Accounts of Chemical Research 2013, 46, (10), 2329-2339.
13. Moreno, C.; Vilas-Varela, M.; Kretz, B.; Garcia-Lekue, A.; Costache, M. V.; Paradinas, M. et al., Bottom-up synthesis of multifunctional nanoporous graphene, Science 2018, 360, (6385), 199-203.
14. Cai, J.; Ruffieux, P.; Jaafar, R.; Bieri, M.; Braun, T.; Blankenburg, S. et al., Atomically precise bottom-up fabrication of graphene nanoribbons, Nature 2010, 466, (7305), 470-473.
15. Compton, O. C.; Nguyen, S. T., Graphene Oxide, Highly Reduced Graphene Oxide, and Graphene: Versatile Building Blocks for Carbon-Based Materials, Small 2010, 6, (6), 711-723.
16. Moon, I. K.; Lee, J.; Ruoff, R. S.; Lee, H., Reduced graphene oxide by chemical graphitization, Nature Communications 2010, 1, (1), 73.
17. Eigler, S.; Dotzer, C.; Hirsch, A., Visualization of defect densities in reduced graphene oxide, Carbon 2012, 50, (10), 3666-3673.
18. Zhang, Y.; Xu, Y., Simultaneous Electrochemical Dual-Electrode Exfoliation of Graphite toward Scalable Production of High-Quality Graphene, Advanced Functional Materials 2019, 29, (37), 1902171.
19. Su, C.-Y.; Lu, A.-Y.; Xu, Y.; Chen, F.-R.; Khlobystov, A. N.; Li, L.-J., High-quality thin graphene films from fast electrochemical exfoliation, ACS Nano 2011, 5, (3), 2332-2339.
20. Parvez, K.; Li, R.; Puniredd, S. R.; Hernandez, Y.; Hinkel, F.; Wang, S.; Feng, X.; Müllen, K., Electrochemically exfoliated graphene as solution-processable, highly conductive electrodes for organic electronics, ACS Nano 2013, 7, (4), 3598-3606.
21. Wang, J.; Manga, K. K.; Bao, Q.; Loh, K. P., High-yield synthesis of few-layer graphene flakes through electrochemical expansion of graphite in propylene carbonate electrolyte, Journal of the American Chemical Society 2011, 133, (23), 8888-8891.
22. Cooper, A. J.; Wilson, N. R.; Kinloch, I. A.; Dryfe, R. A. W., Single stage electrochemical exfoliation method for the production of few-layer graphene via intercalation of tetraalkylammonium cations, Carbon 2014, 66, 340-350.
23. Dalal, M. H.; Lee, C.-Y.; Wallace, G. G., Simultaneous Anodic and Cathodic Exfoliation of Graphite Electrodes in an Aqueous Solution of Inorganic Salt, ChemElectroChem 2021, 8, (16), 3168-3173.
24. Zhang, Y.; Xu, Y.; Liu, R.; Niu, Y., Synthesis of high-quality graphene by electrochemical anodic and cathodic co-exfoliation method, Chemical Engineering Journal 2023, 461, 141985.
25. Armand, M.; Tarascon, J. M., Building better batteries, Nature 2008, 451, (7179), 652-657.
26. Marom, R.; Amalraj, S. F.; Leifer, N.; Jacob, D.; Aurbach, D., A review of advanced and practical lithium battery materials, Journal of Materials Chemistry 2011, 21, (27), 9938-9954.
27. Choi, J. W.; Aurbach, D., Promise and reality of post-lithium-ion batteries with high energy densities, Nature Reviews Materials 2016, 1, (4), 16013.
28. Lin, D.; Liu, Y.; Cui, Y., Reviving the lithium metal anode for high-energy batteries, Nature Nanotechnology 2017, 12, (3), 194-206.
29. Wang, Q.; Liu, B.; Shen, Y.; Wu, J.; Zhao, Z.; Zhong, C.; Hu, W., Confronting the Challenges in Lithium Anodes for Lithium Metal Batteries, Advanced Science 2021, 8, (17), 2101111.
30. Bai, P.; Li, J.; Brushett, F. R.; Bazant, M. Z., Transition of lithium growth mechanisms in liquid electrolytes, Energy & Environmental Science 2016, 9, (10), 3221-3229.
31. Zhang, R.; Chen, X.-R.; Chen, X.; Cheng, X.-B.; Zhang, X.-Q.; Yan, C.; Zhang, Q., Lithiophilic Sites in Doped Graphene Guide Uniform Lithium Nucleation for Dendrite-Free Lithium Metal Anodes, Angewandte Chemie International Edition 2017, 56, (27), 7764-7768.
32. Li, N.; Zhang, K.; Xie, K.; Wei, W.; Gao, Y.; Bai, M.; Gao, Y.; Hou, Q.; Shen, C.; Xia, Z.; Wei, B., Reduced-Graphene-Oxide-Guided Directional Growth of Planar Lithium Layers, Advanced Materials 2020, 32, (7), 1907079.
33. Luo, W.; Gong, Y.; Zhu, Y.; Li, Y.; Yao, Y.; Zhang, Y.; Fu, K.; Pastel, G.; Lin, C.-F.; Mo, Y.; Wachsman, E. D.; Hu, L., Reducing Interfacial Resistance between Garnet-Structured Solid-State Electrolyte and Li-Metal Anode by a Germanium Layer, Advanced Materials 2017, 29, (22), 1606042.
34. Hernandez, Y.; Nicolosi, V.; Lotya, M.; Blighe, F. M.; Sun, Z.; De, S. et al., High-yield production of graphene by liquid-phase exfoliation of graphite, Nature Nanotechnology 2008, 3, (9), 563-568.
35. Abdelkader, A. M.; Kinloch, I. A.; Dryfe, R. A. W., Continuous electrochemical exfoliation of micrometer-sized graphene using synergistic ion intercalations and organic solvents, ACS Applied Materials &Interfaces 2014, 6, (3), 1632-1639.
36. Onthong, U.; Megyes, T.; Bakó, I.; Radnai, T.; Hermansson, K.; Probst, M., Molecular dynamics simulation of lithium iodide in liquid dimethylsulfoxide, Chemical Physics Letters 2005, 401, (1), 217-222.
37. Besenhard, J. O., The electrochemical preparation and properties of ionic alkali metal- and NR4-graphite intercalation compounds in organic electrolytes, Carbon 1976, 14, (2), 111-115.
38. Abe, T.; Fukuda, H.; Iriyama, Y.; Ogumi, Z., Solvated Li-Ion Transfer at Interface Between Graphite and Electrolyte, Journal of The Electrochemical Society 2004, 151, (8), A1120.
39. Yamada, Y.; Takazawa, Y.; Miyazaki, K.; Abe, T., Electrochemical Lithium Intercalation into Graphite in Dimethyl Sulfoxide-Based Electrolytes: Effect of Solvation Structure of Lithium Ion, The Journal of Physical Chemistry C 2010, 114, (26), 11680-11685.
40. Shellikeri, A.; Watson, V.; Adams, D.; Kalu, E. E.; Read, J. A.; Jow, T. R. et al., Investigation of Pre-lithiation in Graphite and Hard-Carbon Anodes Using Different Lithium Source Structures, Journal of The Electrochemical Society 2017, 164, (14), A3914.
41. Ferrari, A. C.; Meyer, J. C.; Scardaci, V.; Casiraghi, C.; Lazzeri, M.; Mauri, F. et al., Raman spectrum of graphene and graphene layers, Physical Review Letters 2006, 97, (18), 187401.

### Example 2. Cathodic Exfoliation of Graphite

Anodic exfoliation enables an efficient 2D material production process with high production rates, but oxidation of the exfoliated product is unavoidable. This can be a major drawback if certain applications, such as electronics, require pure 2D materials with no surface oxidation. To preserve the intrinsic characteristics of 2D materials, cathodic intercalation has some advantages over anodic intercalation, such as being more direct and efficient in producing graphene without oxidation or etching effects.

The cathodic exfoliation process applies negative potential on the working electrode to introduce positively charged cation in a solvated form. The exfoliation efficiency highly depends on the intercalation of cations and the prolonged sonication time. Long sonication time results in exfoliated graphene with reduced grain size. So far, researchers have employed larger size cations or electrolyte with higher concentration of intercalating salts to improve exfoliation efficiency by enhanced intercalation.

This example discusses the cathodic exfoliation of graphene in organic solvents with enforced intercalation of cations. By using organic solvent as an electrolyte medium and adding cations as co-intercalants, the efficiency of graphene production was enhanced by increasing the degree of cation intercalation and interlayer spacing expansion between graphite layers. By varying the ratio of dimethyl carbonate (DMC) solvent, the process can tune the number layers of graphene for different applications.

### Material and Setup

### Electrochemical Exfoliation in Binary Solvents

Graphite foil (thickness of 0.013 cm, Alfa Aesar) was cut into 2 cm×1 cm and used without further treatment. Electrolyte components were lithium perchlorate (LiClO₄), dimethyl sulfoxide (DMSO), and/or DMC. The electrolyte components were purchased from Sigma Aldrich. A mass spectrometer (Cirrus 2, MKS Instruments) was connected to the electrochemical cell in series. Ar gas (ultra-high purity, Airgas) was fed into the electrochemical cell as a carrier gas at a flow rate of 20 mL min⁻¹ controlled by a mass flow controller (G-series, MKS Instruments). Prior to the electrochemical exfoliation, the carrier gas was injected for 2 hr until the signal on the gas analyzer was stabilized. A voltage of −20 V with a compliance current of ˜1 A was applied by a source meter (2400, Keithley) across the electrodes for up to 1 hr. After the exfoliation, the solid products were collected and washed with DI water/ethanol/acetone via a vacuum filtration method, while employing cellulose membrane (0.8 μm, Whatman) as a filter. After the washing, the solid products were transferred to anhydrous N-methyl-pyrrole (NMP, 99.8%, Sigma-Aldrich), followed by sonication for 30 min.

### Characterization

The exfoliated solid products were sampled onto silicon water by Langmuir-Blodgett method and investigated by scanning electron microscopy (SEM, SU8230, Hitachi) operated at 10 kV at working distance of 13 mm, transmission electron microscopy (TEM, HT7700, Hitachi) operated at 120 kV, and atomic force microscopy (AFM, Icon, Bruker). Chemical analysis of the solid products was performed with X-ray photoelectron spectroscopy (XPS, K-Alpha, Thermo Scientific) with Al Kα source and 15 W X-ray gun power on the spot size of 400 μm. A flood gun was used to offset surface charging. The high-resolution Cis peaks were fitted by the XPSPEAKS 4.1 with background type of Shirley and Gaussian-Lorentzian ratio from 5 to 30%. Raman spectroscopy (Qontor Dispersive Raman Spectrometer, Remishaw) was used to investigate defects of the exfoliation products with 1% of 488 nm laser on the spot size of about 1 μm.

### Results and Discussion

FIG. 1A shows the schematic illustration of electrochemical exfoliation in a binary solvent. The graphite foils, prepared as-is, were immersed in the electrolyte in 1 cm×1 cm pieces. A sufficiently low voltage was applied to the graphite foil to ensure both lithium intercalation and electrolyte decomposition. The electrodes were fixed 2 cm apart during the exfoliation process. As soon as the electric potential was applied, visible salts started to form around the graphite surrounding, and the graphite electrode expanded with gas bubbles. In 0.1 M LiClO₄/DMSO, it took only about 2.5 min to delaminate the graphite, and the time increased as the DMC solvent was added to the mixture, allowing sufficient time for intercalation to take place. In 0.1 M LiClO₄/DMSO:DMC (1:3 by vol), the surface color of the graphite turned dark blue, corresponding to LiC₁₈ composition.

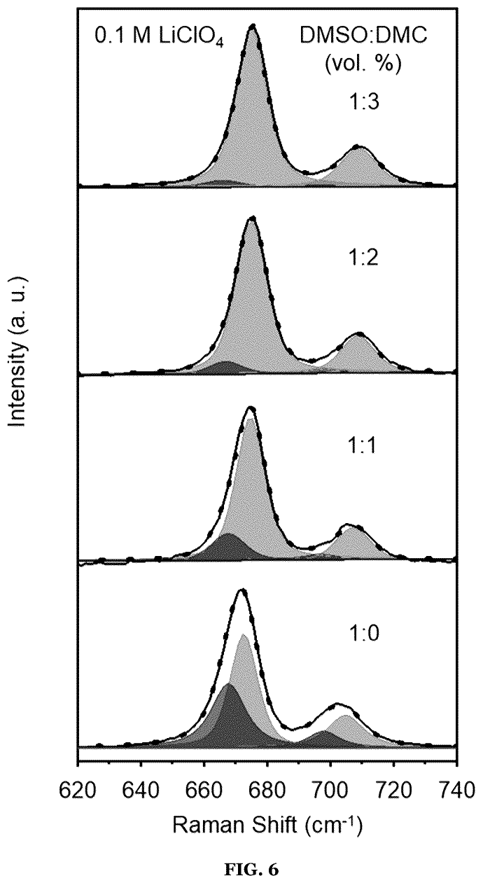

FIG. 6 displays the Raman spectra of 0.1 M LiClO4 DMSO/DMC (1:x by vol, x=1,2,3) within a range of 620-740 cm⁻¹. The Raman spectrum of 1 M LiClO₄/DMSO (1:0 by vol) exhibited four bands at 667, 676, 697, and 708 cm⁻¹, which corresponded to the C—S symmetric and asymmetric stretching modes of DMSO molecules: the bands at 667 and 697 cm⁻¹ from free DMSO and the bands at 676 and 708 cm⁻¹ from solvating DMSO. Hence, both free and solvating DMSO molecules are present in 0.1 M LiClO₄/DMSO:DMC (1:0 by vol). On the other hand, the Raman spectra of 1.0 M LiClO₄/DMSO:DMC (1:3 by vol) hardly reveals the bands from free DMSO molecules (667 and 697 cm⁻¹), implying that almost all the DMSO molecules solvate lithium ion in the solution. Lithium ion is preferentially solvated by DMSO over DMC in DMSO:DMC binary solutions because the interaction of DMSO and lithium ion is much stronger than that of DMC and lithium ion. The solvation number of DMSO molecules towards lithium ion can be estimated from the intensity ratio of the bands from free and solvating DMSO. The solvation number of DMSO molecules towards lithium ion (N_{DMSO}) is anticipated to be close to 2, where it is generally accepted that the N_{DMSO} value is around 4.

In a 0.1 M LiClO₄/DMSO solution where N_{DMSO} is 4, the intercalation of DMSO-solvated lithium ion (co-intercalation of DMSO) mainly took place instead of the intercalation of lithium ion. When the N_{DMSO} value reduced in the 0.1 M LiClO₄/DMSO:DMC (1:1, 1:2, and 1:3 by vol), the co-intercalation of DMSO molecules was less intense whereas the intercalation of lithium ion was enhanced.

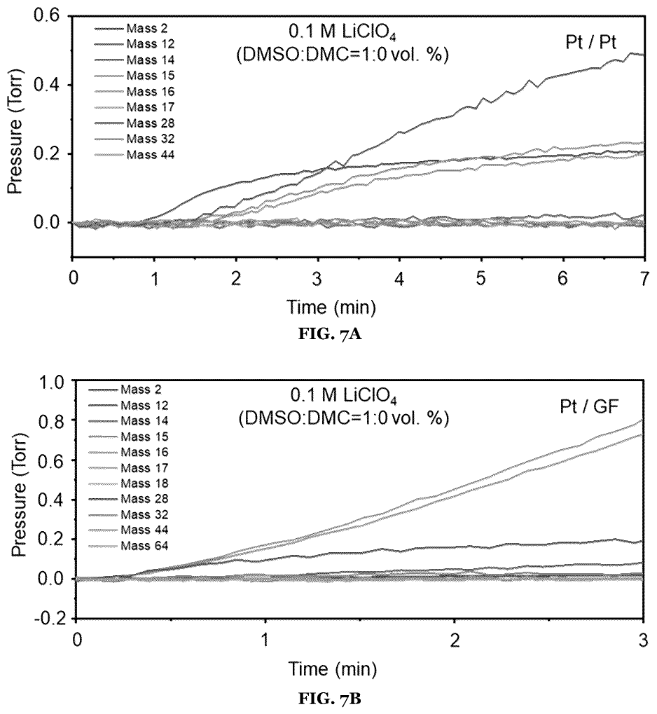

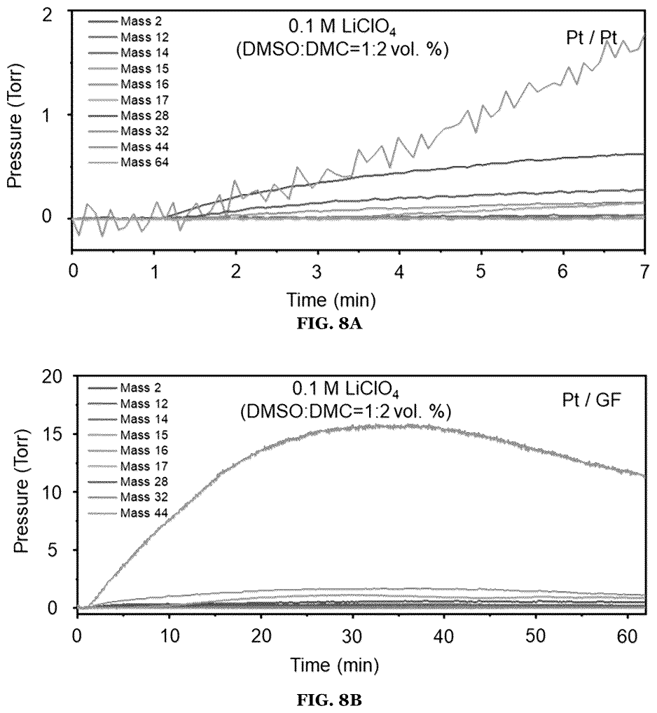

In-situ mass spectroscopy is a great tool to conjecture chemical reactions during the electrochemical exfoliation process. FIGS. 7A-7B and 8A-8B show the mass spectrum during the electrolysis in electrolytes of 0.1 M LiClO₄/DMSO and 0.1 M LiClO₄/DMSO:DMC (1:2 by vol) respectively. The same voltage of −20 V was applied on the Pt wire [FIG. 7A] and graphite foil [FIG. 7B)] electrodes (for 5 min and delamination time respectively). The Pt working electrode was used to verify the difference between the electrolyte decomposition and the chemical reaction with graphite electrode. In case of Pt working electrode, the major gaseous species from electrolyte decomposition were carbon monoxide (CO), hydrogen (H₂), and methane (CH₄) evaluated from the mass peaks of m/z=28, 2, 16, and 15 [FIG. 7A]. Whereas the peak intensity from CO decreases and H₂ disappeared with GF electrode, suggesting that CH₄ gas from DMSO solvent was the major exfoliating gas. CO may have come from the oxidation reaction at the Pt counter electrode.

FIGS. 8A-8B display different mass spectrum when DMC solvent was added to the previous electrolyte. Similar masses were detected with Pt electrodes in 0.1 M LiClO₄/DMSO:DMC (1:2 by vol) to the ones from FIG. 7A. Instead, m/z 15 was enlarged and m/z=44 appeared 2 min after. Interestingly, the spectrum of m/z=15 outstripped the 16 because mass spectrum of CH₄ displays 10:9 (by intensity) ratio of m/z 16 and 15 respectively. This may be due to the formation of a methyl cation (CH₃⁺). The mass spectrum of m/z=15 becomes dominant when graphite foil is used as a working electrode. Also, the mass spectrum of m/z=28 decreases while m/z=44 increases, suggesting that the carbon electrode possibly have worked as electrocatalyst for producing carbon dioxide in binary solvent system.

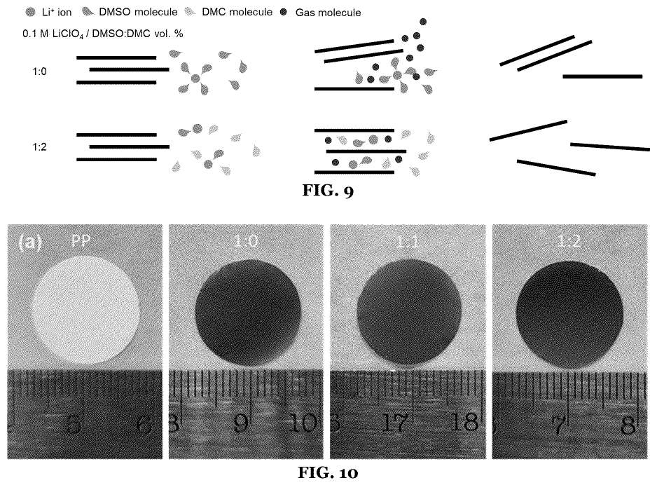

Overall, the process of electrochemical exfoliation of graphite foil in binary solvents is can be repostulated as follows: (1) As soon as the negative voltage is applied on the graphite working electrode, the electrolyte electrically decomposes around the surface of graphite foil to CH₄+, H₂, and CH₄, (2) the decreased solvation number of DMSO molecule made ease for intercalation of Li cation into graphite layers, (3) sufficient shear forces by gaseous species from electrolyte decomposition tears graphene layers, and (4) therefore, efficient intercalation leads to the exfoliation of graphite into fewer layer graphene sheets as described in FIG. 9.

SEM was used to examine the size of exfoliated graphene in different electrolytes, as shown in FIGS. 2A-2C. The results showed that a large number of exfoliated particles from 0.1 M LiClO₄/DMSO were greater than 10 μm in size. Additionally, some smaller sized particles were observed, indicating that bulky exfoliation occurred due to vigorous electrolyte decomposition from co-intercalated DMSO solvent. As the ratio of DMC solvent increased, the size of exfoliated graphene particles began to decrease. Eventually, 61% of them were less than 1 μm in size, indicating a relatively uniform exfoliation process. The sizes of the exfoliated particles were counted and are presented in Table 1.

TABLE 1
The size of exfoliated graphene particles

| Unit: μm | <1 | 1-4 | 5-8 | 8-10 | 10< |
|---|---|---|---|---|---|
| DMSO:DMC (1:0 by vol) | 12 | 6 | 3 | 4 | 44 |
| DMSO:DMC (1:1 by vol) | 21 | 35 | 9 | 2 | 1 |
| DMSO:DMC (1:2 by vol) | 174 | 93 | 12 | 3 | 2 |

FIG. 2E shows multiple layers of graphene flakes from 0.1 M LiClO₄/DMSO with visible stacked edges. These flakes appear darker in color than those from 0.1 M LiClO₄/DMSO:DMC (1:2 by vol.) in FIG. 2F, even when viewed with the same brightness and contrast settings. The number of graphene layers from 0.1 M LiClO₄/DMSO:DMC (1:2 by vol) was determined to be 5-6 layers through scanning transmission electron microscopy (STEM) imaging of the side of the layers [FIG. 2G].

The number of layers from exfoliated graphene particles in binary solvents were confirmed by AFM as shown in FIG. 2H. The inset graph displays height profiles along the lines, and the thickness of 2 nm corresponds to the 5-6 graphene layers which confirms the STEM image in FIG. 2G. The thicknesses of electrochemically exfoliated graphene in 0.1 M LiClO4/DMSO:DMC (1:0 and 1:1 by vol) are found to be over 100 nm and 20-40 nm respectively [FIGS. 2E-2F].

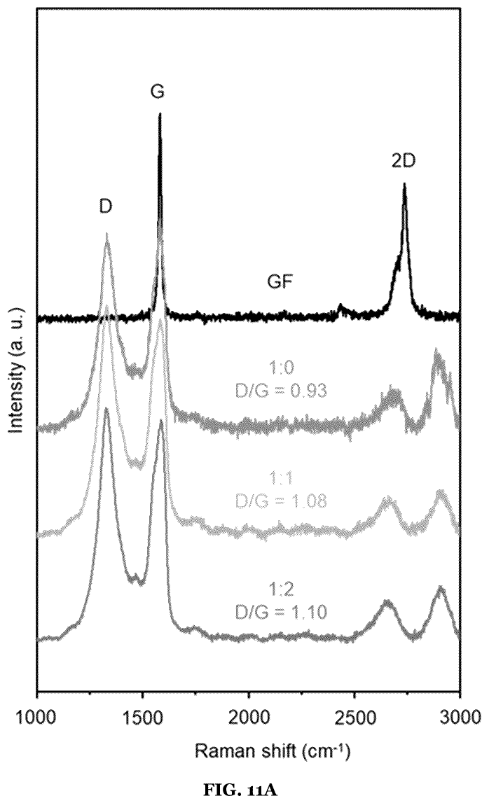

The exfoliated graphene flakes were then vacuum filtered on a porous polypropylene membrane for chemical analysis [FIG. 10]. The loadings of each exfoliated graphene particles from different electrolytes were measured about 0.3 mg and the thickness are 4 μm. The SEM image of FIG. 5A shows well coated graphene layers from 0.1 M LiClO₄/DMSO:DMC (1:2 by vol) on the membrane.

Raman spectroscopy and X-ray photoelectron spectroscopy (XPS) were conducted to investigate the structural differences of graphene products in different electrolytes.

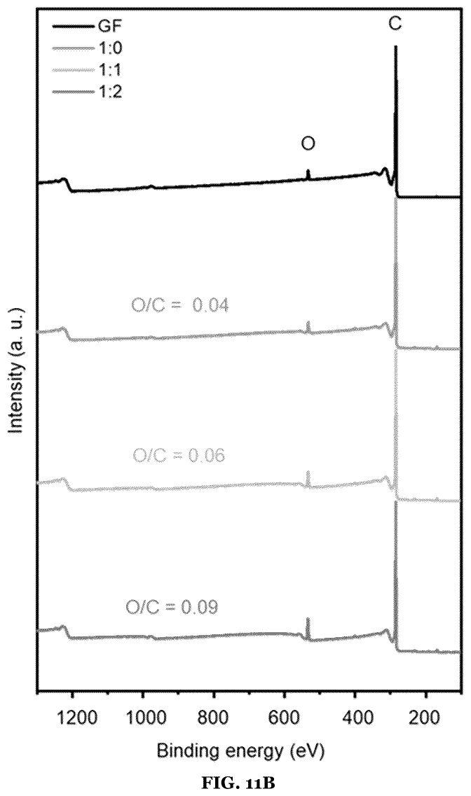

The Raman spectrum of GF showed a characteristic G band (˜1580 cm⁻¹) and doublet of 2D band (2D₁ at ˜2700 cm⁻¹ and 2D₂ at ˜2735 cm⁻¹) [FIG. 11A]. After the electrochemical process, all graphene products showed a strong D band around 1354 cm⁻¹, confirming the lattice distortion and defect formation caused by the exposure from graphene edges and/or catalytic reactions during exfoliation process. Additionally, the graphene products exhibited a broadened 2D band, which is also a hallmark of disordered carbon. The 2D bands shifted from 2683 cm⁻¹ to 2655 cm⁻¹ as DMC solvent was added to the electrolyte. The red shift of 2D bands indicates the decrease of exfoliated graphene layers, and it supports the results from abovementioned AFM data. The survey scan from XPS shows the small amount oxygen content in all exfoliated graphene sheets even from bulk graphite foil [FIG. 11B]. The slight increase in O/C ratios from 1:0 to 1:2 is possibly from DMC solvent residue.

### Conclusion

In short, cathodic exfoliation is a promising process for scalable production of non-oxidized graphene layers. However, cathodic exfoliation has a poorer exfoliation efficiency than anodic exfoliation. The poor intercalation of Li ion during the electrolysis was improved by employing an intercalating solvent, DMC solvent. The solvation number of DMSO solvent around Li⁺ cation and the co-intercalation of DMSO solvent decreased in 0.1 M LiClO₄/DMSO:DMC (1:2 by vol), leading to the exfoliation of graphite into fewer layers. Also, the number of exfoliated graphene layers can be controlled by adjusting the ratio of DMSO and DMC solvent, allowing potential use of the graphene particles in energy storage systems for which will be discussed in the next chapter.

### Example 3. Exemplary Application in Energy Storage System

Lithium metal has long been considered an ideal anode material for lithium-based batteries due to its high gravimetric energy density and potential for improved charge rates. However, challenges such as uncontrolled dendrite growth and interfacial reactions have hindered its widespread adoption. Recent research has focused on using graphene as a protective layer for stable lithium plating and stripping during cell cycling. This approach shows promise in addressing some of the key challenges associated with using lithium metal as an anode material.

Graphene as a single layer of carbon atoms arranged in a hexagonal lattice, has unique properties that make it an attractive material for use in lithium metal batteries. Its high surface area, mechanical strength, and chemical stability make it an ideal candidate for use as a protective layer. By coating the lithium metal anode with graphene, researchers hope to prevent the formation of dendrites and improve the stability of the lithium plating and stripping process.

Despite such advantages, the use of graphene for lithium metal is challenging due to the difficulties in graphene processing. In this example, two strategies are demonstrated for the use of electrochemically exfoliated graphene as a protective layer for lithium metal anodes in lithium metal batteries. Firstly, the exfoliated graphene is directly vacuum filtered on nano-porous membrane separators. Secondly, free-standing covalent organic frameworks (COFs) and electrochemically exfoliated graphene composite are transferred to the PP separator. Both types of separators are tested as a protective layer for lithium metal anode for stable lithium plating and stripping.

### Results and Discussion

### Electrochemically Exfoliated Graphene in Binary Solvents

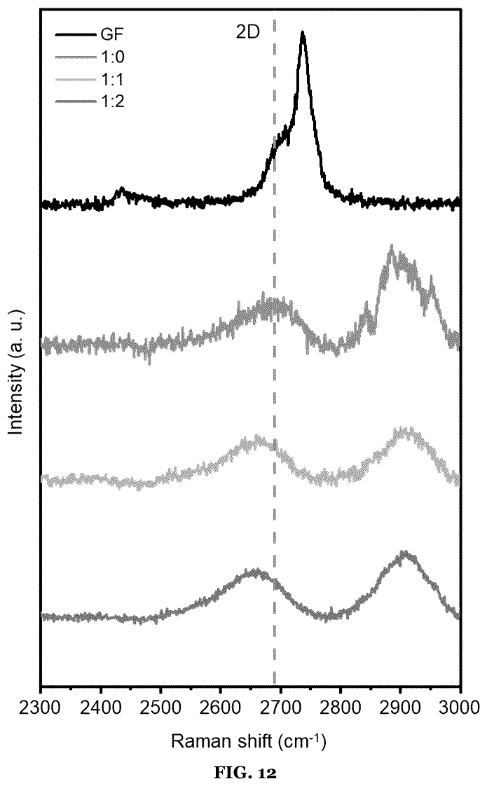

The electrochemical exfoliation of graphite foils was carried out in a binary solvent containing 0.1 M LiClO₄/DMSO:DMC (1:2 by vol.), as described in Chapter 3. The resulting graphene dispersion in NMP solvent was vacuum-filtered using a 25 μm polypropylene (PP) microporous membrane (Celgard). FIG. 12 shows the Raman spectra in the 2300-3000 cm⁻¹ range, where the 2D bands appear. The graphene structures were analyzed at room temperature with 488 nm excitation wavelength. The broad 2D bands observed suggest that all the graphene samples were multilayered, as opposed to single-layer graphene which exhibits a sharp 2D peak. Furthermore, the up-shifted 2D bands were more pronounced with an increasing number of layers. These findings confirm the height profile previously reported by AFM.

With an understanding of how Li plating/stripping behaviors vary depending on carbon types, here the exfoliated graphene coated separators facing Li metal anode were tested for their electrochemical performance as displayed in FIGS. 5C-5F. The exfoliated graphene from binary solvents of 0.1 M LiClO₄/DMSO:DMC (1:0, 1:1, and 1:2 by vol.) are denoted as cathodic(1:0), cathodic(1:1), and cathodic(1:2), respectively. FIG. 5C shows the cycling performance of the full cells within the 2.5-4.0 V region at 25° C. The cells with exfoliated graphene particles show remarkable cycling performance over 200 cycles at 3 mA cm⁻² without significant capacity degradation or short-circuit failure, and slowly decay up to 400 cycles. The electrochemical profile of cathodic(1:2) exhibits minimal change throughout the cycles and followed by cathodic(1:1) then cathodic(1:0). It is noteworthy that the cells exhibited increased capacities and stabilities with decreasing number of graphene layers.

### Increase Salt Concentration of Electrolyte for Inorganic SEI

When metallic Li meets organic electrolyte solvents, SEI forms instantly and continues to grow in thickness. The composition of SEI will transform until the electron transportation in the interface terminates, and it will also evolve during cycling and storage. The SEI is typically ionic conductor and electronic insulator with multi-layers, and a multi-layer mosaic model has been proposed and experimentally verified by previous studies. The SEI is mainly composed of various Li salts, including inorganic LiF, Li₂O, LiOH, Li₂CO₃, and organic ROCO₂Li, Li alkoxides, and Li alkylcarbonates, and the distribution of these SEI components can be adjusted by is electrolyte modification. The layer closer to the Li surface is more inorganic with fully reduced Li salts, while the layer closer to the electrolyte is more organic with partially reduced Li salts. Moreover, the outer organic layer is usually a porous structure, and the inner inorganic layer is relatively compact.

A desirable SEI must have the ability to shield lithium from any further reactions with the electrolyte and should also possess high flexibility to adapt to the volume changes of the Li anode. Additionally, the SEI should insulate the electrons to prevent Li dendrite growth, leading to Li deposition beneath the surface layer. To realize the creation of an interphase with controlled compositions and structure, artificial SEIs have been extensively studied and employed in the protection of Li anodes. LiF has been recognized as the most attractive artificial SEI layer due to its wide electrochemical stability window, low solubility, and mechanical strength. The fabrication of a fluorinated SEI has been accomplished by utilizing fluorinated solvents (FEC and DFEC) and high-concentration Li salts (LiTFSI, LiDFOB, LiBF₄, and LiFSI) in electrolytes, which presents a promising strategy to regulate the behaviour of Li deposition.

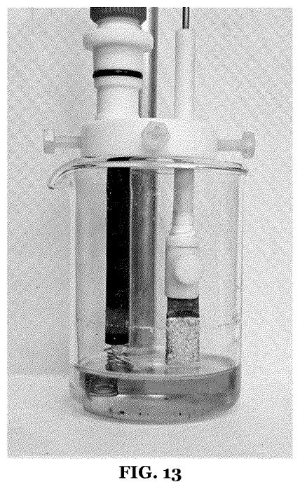

The formation of SEI during the cathodic exfoliation of graphite foil in a binary solvent system was observed. In order to coat graphene exfoliation with an artificial LiF SEI layer, the electrolyte salt was replaced with LiTFSI. The exfoliation process involved applying −20 V (vs Pt wire) to electrochemically exfoliate the graphite foil in 0.1 M, 0.5 M, and 1 M LiTFSI/DMSO:DMC (1:2 by vol.). The delamination behavior of graphite foil in 0.1 M LiTFSI was similar to that observed in 0.1 M LiClO₄ previously. In the case of 0.5 M LiTFSI, the delamination of graphite foil took approximately 90 minutes, which was longer than in 0.1 M LiTFSI (˜60 min). This could be attributed to the increased salt concentration leading to enhanced intercalation of Li ions and decreased gas evolution from electrolyte decomposition. However, 1 M LiTFSI was unable to detach any graphene particles from the graphite foil. Instead, white SEI-like powders precipitated around the graphite foil, as shown in FIG. 13.

The exfoliated graphene particles in 0.1 M and 0.5 M LiTFSI/DMSO:DMC (1:2 by vol.) are vacuum filtered onto PP separator and denoted as 0.1 M LiTFSI and 0.5 M LiTFSI respectively. To analyze the distribution of specific components in the protective film, XPS was performed on 0.1 M LiTFSI and 0.5 M LiTFSI graphene coated separators. The peaks at 289, 285.8, 284.9 eV in the C is spectrum were attributed to carbonates, while the peak at 685.4 eV in the F is spectrum was identified as LiF although trace amount. The presence of C—F compounds was confirmed by the peak at 291.8 eV in the C1s spectra and 689.2 eV in the F is spectra. C—F compounds content which may come from artificial inorganic SEI from decomposition of electrolyte is higher in 0.5 M LiTFSI than 0.1 M LiTFSI suggesting that the amount of inorganic SEI can vary with the concentration of the salt in electrolyte.

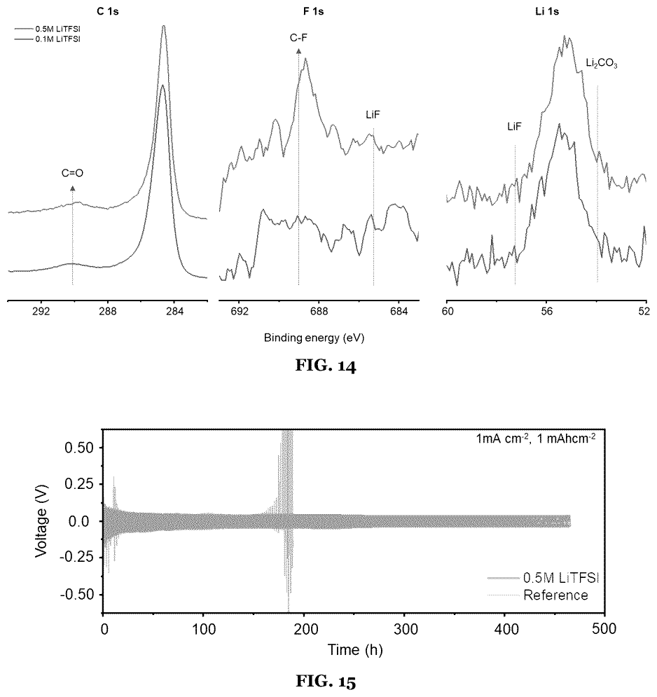

To test long-term cycling, symmetrical Li—Li cells were assembled. Two of the graphene coated separators were used with both facing the Li metal electrodes. Cells with graphene from 0.5 M LiTFSI coated separator can operate for over 450 cycles at 1 mA cm⁻² and a cycling capacity of 1 mAh cm⁻² as depicted in FIG. 14. In contrast, the reference cell with bare PP separator short circuited before 200 cycles. The symmetrical Li/G/LiTFSI/G/Li cells demonstrated impressive interfacial stability against Li metal, as evidenced by the overpotential remaining below 300 mV during the entire cycling process.

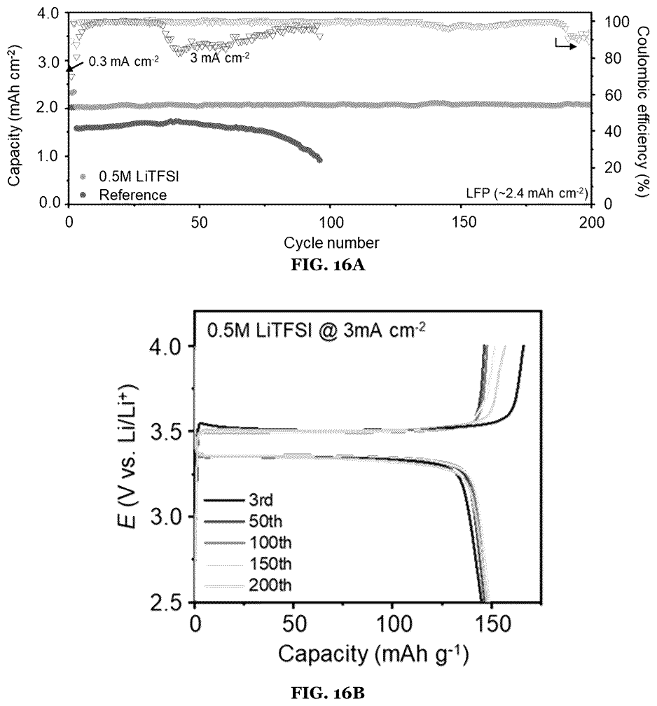

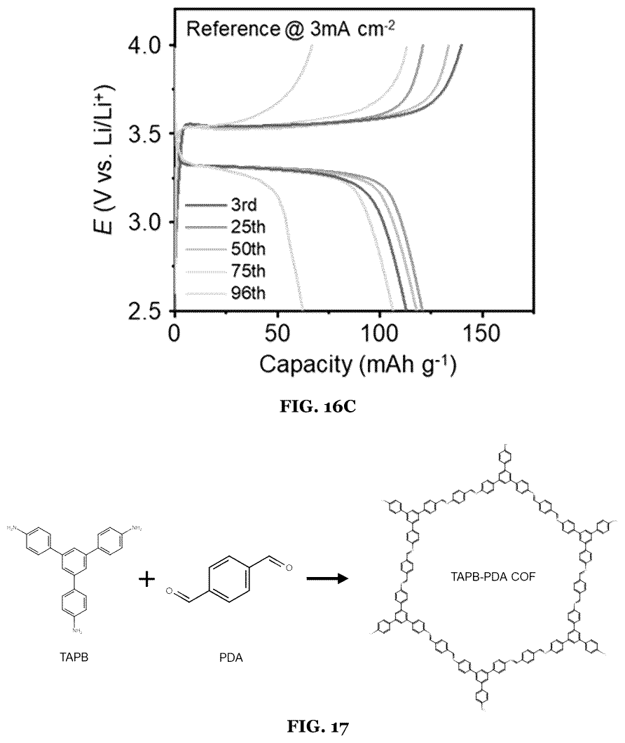

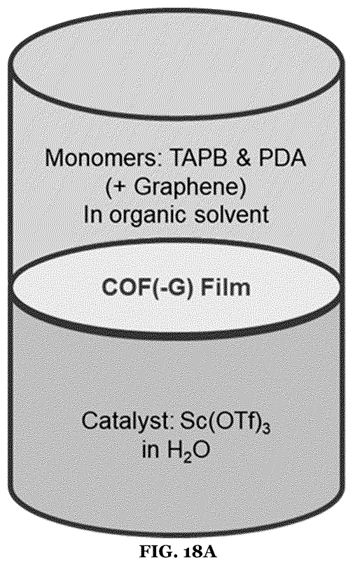

The cycling performance of Li-LFP cells was investigated under practical conditions by using ultrathin Li anode (30 um), high-areal-loading LFP cathodes (˜2.4 mAh cm⁻²) as shown in FIG. 16A. The Li-LFP battery with graphene from 05 M LiTFSI coated separator delivers an initial capacity of 2.03 mAh cm⁻² at 1.2 C (1 C=1.25 mAh cm⁻²) after two activation cycles at 0.12 C, close to that of 2.32 mAh cm⁻² with the electrolyte containing 1 wt. % of LiNO₃. The Li-LFP with 0.5 M LiTFSI graphene displays stable performance of 200 cycles with an average Coulombic efficiency (CE) of 94.2%, indicating that Li metal anodes are stable during cycling. The discharge polarization maintains stable from the 3^{th} to the 200^{th} cycle, indicating Li metal anodes are stabilized with inorganic SEI decorated graphene coated separator [FIG. 16B] compared to the bare PP separator [FIG. 16C].

### Covalent Organic Framework and Graphene Composite

Covalent organic frameworks (COFs) are a type of porous, crystalline materials composed of organic building blocks that are linked together by covalent bonds. They possess high surface area, ordered porosity, and tuneable chemical and physical properties, which make them attractive candidates for a variety of applications, such as gas storage, catalysis, and energy storage. Recently, COF layer on Li (COF—Li) have shown great potential as protective layer for lithium metal anode. A Thin COF layer has a high surface area and can be used to selectively sieve Li ions and guide a uniform Li deposition.

Crystalline, free-standing COF and graphene composite film is synthesized via interfacial polymerization of polyfunctional amines and aldehydes in organic solvent layered at oil-water and air-water interfaces. The method is previously published in 2018 by Matsumoto et. al. and the authors successfully demonstrated continuous COF films with tuneable thickness. 1,3,5-tris(4-aminophenyl)benzene (TAPB) and terephthalaldehyde (PDA) were selected for their well-established structure and extensive previous research. Then, the COFs and graphene composites are expected to improve the performance of lithium metal anode by synergetic effect from both COFs and graphene as protective layer.

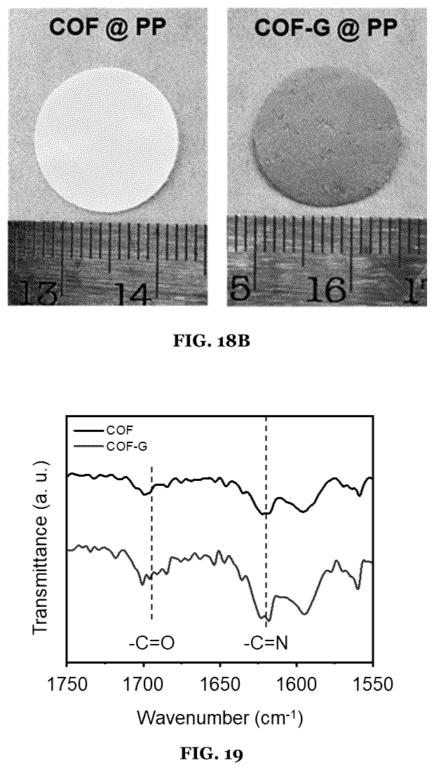

We first studied benzaldehyde as a modulator for the reaction between TAPB and PDA to generate TAPB-PDA COF and followed by adding electrochemically exfoliated graphene [FIG. 18A].

We tested by first studying benzaldehyde as a modulator for the reaction between TAPB and PDA (with graphene) to generate TAPB-PDA COFs (and COF-G) [FIG. 18B]. A 2 mL mixture of 1,4-dioxane/mesitylene solution (4:1 v/v) of TAPB and PDA monomers were layered over an aqueous solution of Sc(OTf)₃ (5 mL, 5 mM) as catalyst in small glass Petri dish. For COF-G, 0.3 mg of graphene particles from anodic exfoliation was added to monomer solution. Reactions were conducted at room temperature, and the polymerization provided a thin film after 2 days. The films were transferred onto PP separators and washed for further analysis. [FIG. 18B]. The successful polymerization of TAPB and PDA to form the target TAPB-PDA COF was confirmed through Fourier-transform infrared spectroscopy (FTIR) measurements [FIG. 1]. The formation of imine bonds was indicated by the appearance of a C═N stretching vibration band at 1619 cm⁻¹ and the attenuation of the aldehyde band at 1681 cm⁻¹ under FTIR analysis for both COF and COF-G.

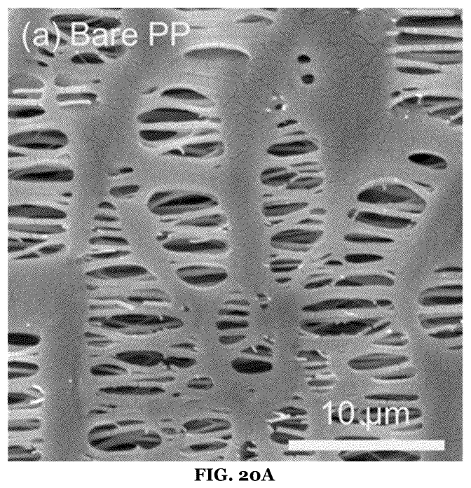

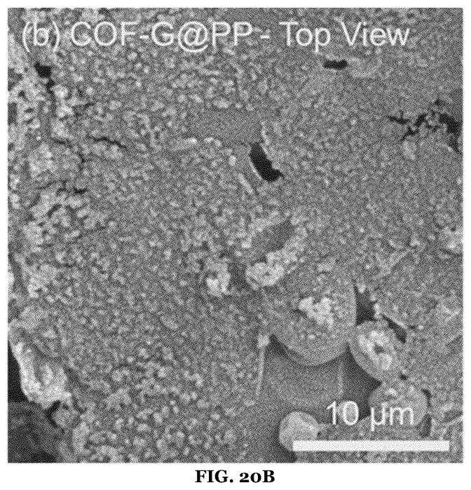

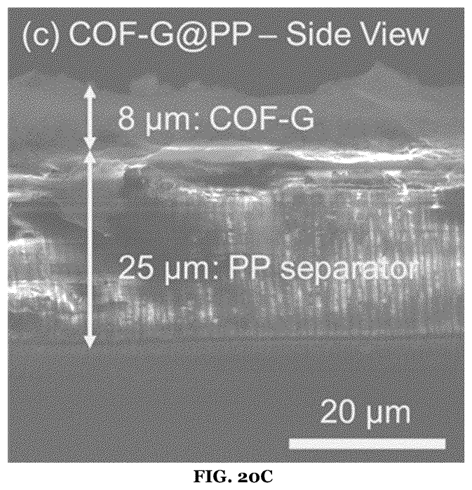

The morphological structure of the COF-G was also examined, and the results were shown in FIGS. 20A-20C. By looking at top-views of bare PP separator and COF-G coated PP separator in FIG. 20A and FIG. 20B respectively, COF-G covered PP separator horizontally, and TAPB-PDA COF coated around the graphene sheets.

From FIG. 20C, the cross-sectional side view of COF-G shows that the TAPB-PDA COFs and graphene form mixed composite rather than bi-layered structure. The is observation indicates that the graphene sheets in monomer solution worked as a substrate for polymerization of TAPB-PDA COFs.

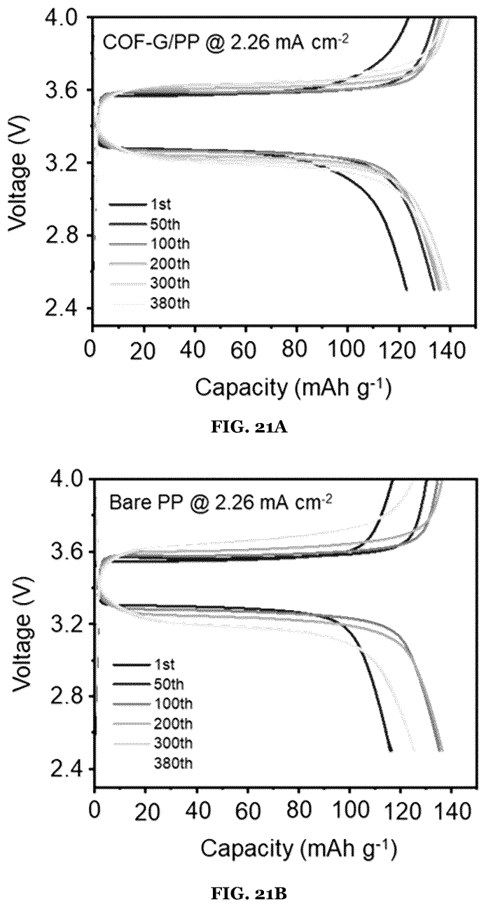

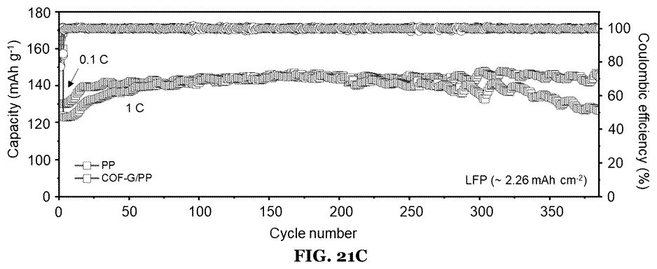

A Li∥COF-G∥LiPF₆∥LFP full cell using 1 M LiPF₆/EC:DEC (1:1 wt. %) with 10% FEC exhibit similar initial charge and discharge voltage profiles, yielding a specific capacity of 120 mAh g⁻¹ compared to bare PP separator as depicted in FIGS. 21A-21B. Following further cycling, the full cells with the COF-G coated separator display superior cycling stability, maintaining over 100% of their initial capacity after 380 cycles as shown in FIG. 21C, and still on going. In contrast, the battery with the bare PP separator rapidly degrades after 200 cycles.

### Experimental

### Inorganic SEI Decorated Graphene as Protective Layer

All the electrochemical measurements were conducted at room temperature in 2032 type coin-cells which assembled in an Ar-filled glove box (Mbraun, O₂ and H₂O<0.1 ppm).

### Li Symmetric Cell

Li metals (thickness: 250 μm) and graphene coated polypropylene membrane (Celgard 2500) were used as electrodes and separator. 1 M lithium hexafluorophosphate (LiPF₆) in ethylene carbonate (EC):diethyl carbonate (DEC) (1:1 v/v %) with 5 wt. % of fluoroethylene carbonate (FEC) were used as the electrolyte for symmetric Li cells.

### Electrode Preparation

LiFePO₄ (LFP) cathode was prepared using a slurry casting technique. LFP powders, Super P carbons as a conductive additive, polyvinylidene fluoride (PVDF) as a binder were dissolved in N-methyl-2-pyrrolidone (NMP) with a weight ratio of 8:1:1 to make a slurry and then coated onto a current collector of aluminium foil. The cathodes were dried in a vacuum oven at 65° C. for 24 hr. The areal capacity of LFP cathodes were ˜2.4 mAh cm⁻².

### Full Cell

Li metals (thickness: 30 μm) and LFP cathodes were used as electrodes. The electrolyte was composed of 1 M LiTFSI in 1,3-dioxolane (DOL):1,2-dimethoxyethane (DME) (1:1, by vol.) with 1 wt. % of LiNO₃. The electrolytes and 2032 type coin-cells were prepared in an Ar-filled glove box with H₂O and O₂ contents below 1.0 ppm.

### Covalent Organic Framework and Graphene Composite

### Full Cell

The same protocol was used as stated above for electrode preparation and full-cell assembly, instead the the areal capacity of LFP cathodes were ˜2.7 mAh cm⁻² and the thickness of Li metal was 500 um.

### Conclusion

The example demonstrated the use of electrochemically exfoliated graphene in the energy storage system, particularly in lithium metal anodes for LMBs. The first strategy employs vacuum filtration of exfoliated graphene on PP separator. The exfoliated graphene with fewer layers yields better cycling performance with higher and less decaying capacities. Also, graphene decorated with inorganic SEI was obtained by changing the electrolyte salt with fluorine rich LiTFSI and exhibited superior cycling performance. Secondly, graphene is involved in the process during interfacial polymerization of COFs to synthesize COFs and graphene composite. Agreeing with past studies, COF-G yielded improved electrochemical performance.

Symbols and Abbreviations

| | |
|---|---|
| 2D | Two-dimensional |
| RE | Reference electrode |
| LIBs | Lithium-ion batteries |
| LMBs | Lithium metal batteries |
| SEI | Solid electrolyte interphase |
| CE | Coulombic efficiency |
| DFT | Density functional theory |
| CV | Cyclic voltammetry |
| DI water | Deionized water |
| DMF | Dimethylformamide |
| TEM | Transmission electron microscopy |
| SEM | Scanning electron microscopy |
| AFM | Atomic force microscopy |
| XPS | X-ray photoelectron spectroscopy |
| PAW | Project-augmented wave |
| DMC | Dimethyl carbonate |
| DMSO | Dimethyl sulfoxide |
| NMP | N-methyl-pyrrole |
| STEM | Scanning transmission electron microscopy |
| PP | Polypropylene |
| FEC | fluoroethylene carbonate |
| DFEC | Difluoroethylene carbonate |
| LFP | Lithium iron phosphate |
| TAPB | 1,3,5-tris(4-aminophenyl)benzene |
| PDA | Terephthalaldehyde |
| FTIR | Fourier-transform infrared spectroscopy |
| PVDF | Polyvinylidene fluoride |
| EC | Ethylene carbonate |
| DEC | Diethyl carbonate |
| DOL | 1,3-dioxolane |
| DME | 1,2-dimethoxyethane |

### References for Examples 2 and 3

[1] K. S. Novoselov et al., “Electric Field Effect in Atomically Thin Carbon Films,” Science, vol. 306, no. 5696, pp. 666-669, 2004/10/22 2004.
[2] D. G. Papageorgiou, I. A. Kinloch, and R. J. Young, “Mechanical properties of graphene and graphene-based nanocomposites,” Prog. Mater. Sci., vol. 90, pp. 75-127, 2017/10/01/2017.
[3] A. A. Balandin, “Thermal properties of graphene and nanostructured carbon materials,” Nat. Mater., vol. 10, no. 8, pp. 569-581, 2011/08/01 2011.
[4] T. V. Cuong et al., “Optoelectronic properties of graphene thin films prepared by thermal reduction of graphene oxide,” Mater. Lett., vol. 64, no. 6, pp. 765-767, 2010/03/31/2010.
[5] M.-S. Cao, X.-X. Wang, W.-Q. Cao, and J. Yuan, “Ultrathin graphene: electrical properties and highly efficient electromagnetic interference shielding,” J. Mater. Chem. C, vol. 3, no. 26, pp. 6589-6599, 2015.
[6] X. Ling, H. Wang, S. Huang, F. Xia, and M. S. Dresselhaus, “The renaissance of black phosphorus,” Proceedings of the National Academy of Sciences, vol. 112, no. 15, pp. 4523-4530, 2015/04/14 2015.
[7] S. Manzeli, D. Ovchinnikov, D. Pasquier, O. V. Yazyev, and A. Kis, “2D transition metal dichalcogenides,” Nature Reviews Materials, vol. 2, no. 8, p. 17033, 2017/06/13 2017.
[8] B. Anasori, M. R. Lukatskaya, and Y. Gogotsi, “2D metal carbides and nitrides (MXenes) for energy storage,” Nature Reviews Materials, vol. 2, no. 2, p. 16098, 2017/01/17 2017.
[9] K. Zhang, Y. Feng, F. Wang, Z. Yang, and J. Wang, “Two dimensional hexagonal boron nitride (2D-hBN): synthesis, properties and applications,” J. Mater.

Chem. C, vol. 5, no. 46, pp. 11992-12022, 2017.
[10] J. W. Colson et al., “Oriented 2D Covalent Organic Framework Thin Films on Single-Layer Graphene,” Science, vol. 332, no. 6026, pp. 228-231, 2011/04/08 2011.
[11] J. R. Schaibley et al., “Valleytronics in 2D materials,” Nature Reviews Materials, vol. 1, no. 11, p. 16055, 2016/08/23 2016.
[12] R. Mas-Ballesté, C. Gómez-Navarro, J. Gómez-Herrero, and F. Zamora, “2D materials: to graphene and beyond,” Nanoscale, vol. 3, no. 1, pp. 20-30, 2011.
[13] A. Gupta, T. Sakthivel, and S. Seal, “Recent development in 2D materials beyond graphene,” Prog. Mater. Sci., vol. 73, pp. 44-126, 2015/08/01/2015.
[14] K. S. Novoselov, A. Mishchenko, A. Carvalho, and A. H. Castro Neto, “2D materials and van der Waals heterostructures,” Science, vol. 353, no. 6298, p. aac9439, 2016/07/29 2016.
[15] D. S. Schulman, A. J. Arnold, and S. Das, “Contact engineering for 2D materials and devices,” Chemical Society Reviews, vol. 47, no. 9, pp. 3037-3058, 2018.
[16] K. Chen, S. Song, F. Liu, and D. Xue, “Structural design of graphene for use in electrochemical energy storage devices,” Chemical Society Reviews, vol. 44, no. 17, pp. 6230-6257, 2015.
[17] R. Raccichini, A. Varzi, S. Passerini, and B. Scrosati, “The role of graphene for electrochemical energy storage,” Nat. Mater., vol. 14, no. 3, pp. 271-279, 2015/03/01 2015.
[18] A. F. Khan, D. A. C. Brownson, E. P. Randviir, G. C. Smith, and C. E. Banks, “2D Hexagonal Boron Nitride (2D-hBN) Explored for the Electrochemical Sensing of Dopamine,” Anal. Chem., vol. 88, no. 19, pp. 9729-9737, 2016/10/04 2016.
[19] H. Ilatikhameneh, Y. Tan, B. Novakovic, G. Klimeck, R. Rahman, and J. Appenzeller, “Tunnel Field-Effect Transistors in 2-D Transition Metal Dichalcogenide Materials,” IEEE Journal on Exploratory Solid-State Computational Devices and Circuits, vol. 1, pp. 12-18, 2015.
[20] B. Mendoza-Sánchez and Y. Gogotsi, “Synthesis of Two-Dimensional Materials for Capacitive Energy Storage,” Adv. Mater., vol. 28, no. 29, pp. 6104-6135, 2016/08/01 2016.
[21] V. Shanmugam et al., “A Review of the Synthesis, Properties, and Applications of 2D Materials,” Particle & Particle Systems Characterization, vol. 39, no. 6, p. 2200031, 2022/06/01 2022.
[22] B. Deng, Z. Liu, and H. Peng, “Toward Mass Production of CVD Graphene Films,” Adv. Mater., vol. 31, no. 9, p. 1800996, 2019/03/01 2019.
[23] C. Backes et al., “Production and processing of graphene and related materials,” 2D Mater., vol. 7, no. 2, p. 022001, 2020/01/29 2020.
[24] W. A. de Heer et al., “Epitaxial graphene,” Solid State Communications, vol. 143, no. 1, pp. 92-100, 2007/07/01/2007.
[25] P. W. Sutter, J.-I. Flege, and E. A. Sutter, “Epitaxial graphene on ruthenium,” Nat. Mater., vol. 7, no. 5, pp. 406-411, 2008/05/01 2008.
[26] L. Gao, J. R. Guest, and N. P. Guisinger, “Epitaxial Graphene on Cu(111),” Nano Lett., vol. 10, no. 9, pp. 3512-3516, 2010/09/08 2010.
[27] G. Li et al., “Epitaxial growth and physical properties of 2D materials beyond graphene: from monatomic materials to binary compounds,” Chemical Society Reviews, vol. 47, no. 16, pp. 6073-6100, 2018.
[28] J. L. Zhang et al., “2D Phosphorene: Epitaxial Growth and Interface Engineering for Electronic Devices,” Adv. Mater., vol. 30, no. 47, p. 1802207, 2018/11/01 2018.
[29] L. Zhang, P. Peng, and F. Ding, “Epitaxial Growth of 2D Materials on High-Index Substrate Surfaces,” Adv. Funct. Mater., vol. 31, no. 29, p. 2100503, 2021/07/01 2021.
[30] M. Choucair, P. Thordarson, and J. A. Stride, “Gram-scale production of graphene based on solvothermal synthesis and sonication,” Nature Nanotechnology, vol. 4, no. 1, pp. 30-33, 2009/01/01 2009.
[31] A. V. Murugan, T. Muraliganth, and A. Manthiram, “Rapid, Facile Microwave-Solvothermal Synthesis of Graphene Nanosheets and Their Polyaniline Nanocomposites for Energy Strorage,” Chem. Mat., vol. 21, no. 21, pp. 5004-5006, 2009/11/10 2009.
[32] D. Deng et al., “Toward N-Doped Graphene via Solvothermal Synthesis,” Chem. Mat., vol. 23, no. 5, pp. 1188-1193, 2011/03/08 2011.
[33] L. Chen, Y. Hernandez, X. Feng, and K. Müllen, “From Nanographene and Graphene Nanoribbons to Graphene Sheets: Chemical Synthesis,” Angewandte Chemie International Edition, vol. 51, no. 31, pp. 7640-7654, 2012/07/27 2012.
[34] S. Eigler et al., “Wet Chemical Synthesis of Graphene,” Adv. Mater., vol. 25, no. 26, pp. 3583-3587, 2013/07/12 2013.
[35] G. Huang et al., “Graphene-Like MoS2/Graphene Composites: Cationic Surfactant-Assisted Hydrothermal Synthesis and Electrochemical Reversible Storage of Lithium,” Small, vol. 9, no. 21, pp. 3693-3703, 2013/11/11 2013.
[36] C. Berger et al., “Ultrathin Epitaxial Graphite: 2D Electron Gas Properties and a Route toward Graphene-based Nanoelectronics,” The Journal of Physical Chemistry B, vol. 108, no. 52, pp. 19912-19916, 2004/12/01 2004.
[37] E. Loginova, N. C. Bartelt, P. J. Feibelman, and K. F. McCarty, “Evidence for graphene growth by C cluster attachment,” New Journal of Physics, vol. 10, no. 9, p. 093026, 2008/09/25 2008.
[38] E. Moreau et al., “Graphene growth by molecular beam epitaxy on the carbon-face of SiC,” Applied Physics Letters, vol. 97, no. 24, p. 241907, 2010/12/13 2010.
[39] C.-L. Song et al., “Molecular-beam epitaxy and robust superconductivity of stoichiometric FeSe crystalline films on bilayer graphene,” Physical Review B, vol. 84, no. 2, p. 020503, 07/12/2011.
[40] J. M. Garcia et al., “Graphene growth on h-BN by molecular beam epitaxy,” Solid State Communications, vol. 152, no. 12, pp. 975-978, 2012/06/01/2012.
[41] K. S. Kim et al., “Large-scale pattern growth of graphene films for stretchable transparent electrodes,” Nature, vol. 457, no. 7230, pp. 706-710, 2009/02/01 2009.
[42] Y. Zhang, L. Zhang, and C. Zhou, “Review of Chemical Vapor Deposition of Graphene and Related Applications,” Accounts of Chemical Research, vol. 46, no. 10, pp. 2329-2339, 2013/10/15 2013.
[43] H. F. Liu, S. L. Wong, and D. Z. Chi, “CVD Growth of MoS2-based Two-dimensional Materials,” Chemical Vapor Deposition, vol. 21, no. 10-11-12, pp. 241-259, 2015/12/01 2015.
[44] X. Li, L. Colombo, and R. S. Ruoff, “Synthesis of Graphene Films on Copper Foils by Chemical Vapor Deposition,” Advanced Materials, vol. 28, no. 29, pp. 6247-6252, 2016/08/01 2016.
[45] S. M. Kim et al., “Synthesis of large-area multilayer hexagonal boron nitride for high material performance,” Nature Communications, vol. 6, no. 1, p. 8662, 2015/10/28 2015.
[46] H. Yu et al., “Wafer-Scale Growth and Transfer of Highly-Oriented Monolayer MoS2 Continuous Films,” ACS Nano, vol. 11, no. 12, pp. 12001-12007, 2017/12/26 2017.
[47] J. Shim et al., “Controlled crack propagation for atomic precision handling of wafer-scale two-dimensional materials,” Science, vol. 362, no. 6415, pp. 665-670, 2018/11/09 2018.
[48] Z. Gao et al., “Large-area epitaxial growth of curvature-stabilized ABC trilayer graphene,” Nature Communications, vol. 11, no. 1, p. 546, 2020/01/28 2020.
[49] M. Wang et al., “Single-crystal, large-area, fold-free monolayer graphene,” Nature, vol. 596, no. 7873, pp. 519-524, 2021/08/01 2021.
[50] X. Zhang, L. Hou, A. Ciesielski, and P. Samori, “2D Materials Beyond Graphene for High-Performance Energy Storage Applications,” Advanced Energy Materials, vol. 6, no. 23, p. 1600671, 2016/12/01 2016.
[51] W. S. Hummers, Jr. and R. E. Offeman, “Preparation of Graphitic Oxide,” J. Am. Chem. Soc., vol. 80, no. 6, pp. 1339-1339, 1958/03/011958.
[52] G. Eda, H. Yamaguchi, D. Voiry, T. Fujita, M. Chen, and M. Chhowalla, “Photoluminescence from Chemically Exfoliated MoS2,” Nano Lett., vol. 11, no. 12, pp. 5111-5116, 2011/12/14 2011.
[53] M. Yi and Z. Shen, “A review on mechanical exfoliation for the scalable production of graphene,” J. Mater. Chem. A, vol. 3, no. 22, pp. 11700-11715, 2015.
[54] J. N. Coleman et al., “Two-Dimensional Nanosheets Produced by Liquid Exfoliation of Layered Materials,” Science, vol. 331, no. 6017, pp. 568-571, 2011/02/04 2011.
[55] Y. Hernandez et al., “High-yield production of graphene by liquid-phase exfoliation of graphite,” Nature Nanotechnology, vol. 3, no. 9, pp. 563-568, 2008/09/01 2008.
[56] K. R. Paton et al., “Scalable production of large quantities of defect-free few-layer graphene by shear exfoliation in liquids,” Nat. Mater., vol. 13, no. 6, pp. 624-630, 2014/06/01 2014.
[57] E. Varrla et al., “Turbulence-assisted shear exfoliation of graphene using household detergent and a kitchen blender,” Nanoscale, vol. 6, no. 20, pp. 11810-11819, 2014.
[58] G. Guan et al., “Protein Induces Layer-by-Layer Exfoliation of Transition Metal Dichalcogenides,” J. Am. Chem. Soc., vol. 137, no. 19, pp. 6152-6155, 2015/05/20 2015.
[59] K. S. Novoselov, V. I. Fal'ko, L. Colombo, P. R. Gellert, M. G. Schwab, and K. Kim, “A roadmap for graphene,” Nature, vol. 490, no. 7419, pp. 192-200, 2012/10/01 2012.
[60] J. Lu, J.-x. Yang, J. Wang, A. Lim, S. Wang, and K. P. Loh, “One-Pot Synthesis of Fluorescent Carbon Nanoribbons, Nanoparticles, and Graphene by the Exfoliation of Graphite in Ionic Liquids,” ACS Nano, vol. 3, no. 8, pp. 2367-2375, 2009/08/25 2009.
[61] J. Wang, K. K. Manga, Q. Bao, and K. P. Loh, “High-Yield Synthesis of Few-Layer Graphene Flakes through Electrochemical Expansion of Graphite in Propylene Carbonate Electrolyte,” Journal of the American Chemical Society, vol. 133, no. 23, pp. 8888-8891, 2011/06/15 2011.
[62] J. Huang et al., “Electrochemical Exfoliation of Pillared-Layer Metal-Organic Framework to Boost the Oxygen Evolution Reaction,” Angewandte Chemie International Edition, vol. 57, no. 17, pp. 4632-4636, 2018/04/16 2018.
[63] J. Lee, S. Noh, N. D. Pham, and J. H. Shim, “Top-down synthesis of S-doped graphene nanosheets by electrochemical exfoliation of graphite: Metal-free bifunctional catalysts for oxygen reduction and evolution reactions,” Electrochimica Acta, vol. 313, pp. 1-9, 2019/08/01/2019.
[64] Y. Zhang, X. Zhang, Y. Ling, F. Li, A. M. Bond, and J. Zhang, “Controllable Synthesis of Few-Layer Bismuth Subcarbonate by Electrochemical Exfoliation for Enhanced C02 Reduction Performance,” Angewandte Chemie International Edition, vol. 57, no. 40, pp. 13283-13287, 2018/10/01 2018.
[65] S. X. Leong, C. C. Mayorga-Martinez, X. Chia, J. Luxa, Z. Sofer, and M. Pumera, “2H→1T Phase Change in Direct Synthesis of WS2 Nanosheets via Solution-Based Electrochemical Exfoliation and Their Catalytic Properties,” ACS Applied Materials & Interfaces, vol. 9, no. 31, pp. 26350-26356, 2017/08/09 2017.
[66] X. Zhao et al., “Electrochemical exfoliation of graphene as an anode material for ultra-long cycle lithium ion batteries,” Journal of Physics and Chemistry of Solids, vol. 139, p. 109301, 2020/04/01/2020.
[67] Y. Munaiah, P. Ragupathy, and V. K. Pillai, “Single-Step Synthesis of Halogenated Graphene through Electrochemical Exfoliation and Its Utilization as Electrodes for Zinc Bromine Redox Flow Battery,” Journal of The Electrochemical Society, vol. 163, no. 14, pp. A2899-A2910, 2016.
[68] H. Shuai et al., “Electrochemically Exfoliated Phosphorene-Graphene Hybrid for Sodium-Ion Batteries,” Small Methods, vol. 3, no. 2, p. 1800328, 2019/02/01 2019.
[69] Y. Yang et al., “Controllable fabrication of two-dimensional layered transition metal oxides through electrochemical exfoliation of non-van der Waals metals for rechargeable zinc-ion batteries,” Chemical Engineering Journal, vol. 408, p. 127247, 2021/03/15/2021.
[70] A. Jamaluddin et al., “Fluorinated graphene as a dual-functional anode to achieve dendrite-free and high-performance lithium metal batteries,” Carbon, vol. 197, pp. 141-151, 2022/09/01/2022.
[71] A. Ejigu et al., “On the Role of Transition Metal Salts During Electrochemical Exfoliation of Graphite: Antioxidants or Metal Oxide Decorators for Energy Storage Applications,” Adv. Funct. Mater., vol. 28, no. 48, p. 1804357, 2018/11/01 2018.
[72] Z. Liu, Z.-S. Wu, S. Yang, R. Dong, X. Feng, and K. Müllen, “Ultraflexible In-Plane Micro-Supercapacitors by Direct Printing of Solution-Processable Electrochemically Exfoliated Graphene,” Advanced Materials, vol. 28, no. 11, pp. 2217-2222, 2016/03/01 2016.
[73] Z. Dou, Z. Qin, Y. Shen, S. Hu, N. Liu, and Y. Zhang, “High-performance flexible supercapacitor based on carbon cloth through in-situ electrochemical exfoliation and re-deposition in neutral electrolyte,” Carbon, vol. 153, pp. 617-624, 2019/11/01/2019.
[74] P. Das, L. Zhang, S. Zheng, X. Shi, Y. Li, and Z.-S. Wu, “Rapid fabrication of high-quality few-layer graphene through gel-phase electrochemical exfoliation of graphite for high-energy-density ionogel-based micro-supercapacitors,” Carbon, vol. 196, pp. 203-212, 2022/08/30/2022.
[75] M. B. Erande, M. S. Pawar, and D. J. Late, “Humidity Sensing and Photodetection Behavior of Electrochemically Exfoliated Atomically Thin-Layered Black Phosphorus Nanosheets,” ACS Applied Materials & Interfaces, vol. 8, no. 18, pp. 11548-11556, 2016/05/11 2016.
[76] G. Maccaferri et al., “Highly sensitive amperometric sensor for morphine detection based on electrochemically exfoliated graphene oxide. Application in screening tests of urine samples,” Sensors and Actuators B: Chemical, vol. 281, pp. 739-745, 2019/02/15/2019.
[77] J. Li et al., “Electrochemical Exfoliation of Naturally Occurring Layered Mineral Stibnite (Sb2S3) for Highly Sensitive and Fast Room-Temperature Acetone Sensing,” Advanced Materials Interfaces, vol. 9, no. 19, p. 2200605, 2022/07/01 2022.
[78] P. Shukla, P. Saxena, D. Madhwal, N. Bhardwaj, and V. K. Jain, “Battery-operated resistive sensor based on electrochemically exfoliated pencil graphite core for room temperature detection of LPG,” Sensors and Actuators B: Chemical, vol. 343, p. 130133, 2021/09/15/2021.
[79] M. U. Arshad et al., “Multi-functionalized fluorinated graphene composite coating for achieving durable electronics: Ultralow corrosion rate and high electrical insulating passivation,” Carbon, vol. 195, pp. 141-153, 2022/08/15/2022.
[80] K. Parvez et al., “Electrochemically Exfoliated Graphene as Solution-Processable, Highly Conductive Electrodes for Organic Electronics,” ACS Nano, vol. 7, no. 4, pp. 3598-3606, 2013/04/23 2013.
[81] Y. Kim, Y. J. Kwon, J.-Y. Hong, M. Park, C. J. Lee, and J. U. Lee, “Spray coating of electrochemically exfoliated graphene/conducting polymer hybrid electrode for organic field effect transistor,” Journal of Industrial and Engineering Chemistry, vol. 68, pp. 399-405, 2018/12/25/2018.
[82] A. Ejigu, I. A. Kinloch, and R. A. W. Dryfe, “Single Stage Simultaneous Electrochemical Exfoliation and Functionalization of Graphene,” ACS Applied Materials & Interfaces, vol. 9, no. 1, pp. 710-721, 2017/01/11 2017.
[83] Y. Zhuo, I. A. Kinloch, and M. A. Bissett, “Simultaneous Electrochemical Exfoliation and Chemical Functionalization of Graphene for Supercapacitor Electrodes,” Journal of The Electrochemical Society, vol. 167, no. 11, p. 110531, 2020/07/17 2020.
[84] S. Fang, Y. Lin, and Y. H. Hu, “Recent Advances in Green, Safe, and Fast Production of Graphene Oxide via Electrochemical Approaches,” ACS Sustainable Chemistry & Engineering, vol. 7, no. 15, pp. 12671-12681, 2019/08/05 2019.
[85] N. Parveen, M. O. Ansari, S. A. Ansari, and M. H. Cho, “Simultaneous sulfur doping and exfoliation of graphene from graphite using an electrochemical method for supercapacitor electrode materials,” Journal of Materials Chemistry A, vol. 4, no. 1, pp. 233-240, 2016.
[86] X. Lu and C. Zhao, “Controlled electrochemical intercalation, exfoliation and in situ nitrogen doping of graphite in nitrate-based protic ionic liquids,” Physical Chemistry Chemical Physics, vol. 15, no. 46, pp. 20005-20009, 2013.
[87] V. Thirumal et al., “Single pot electrochemical synthesis of functionalized and phosphorus doped graphene nanosheets for supercapacitor applications,” Journal of Materials Science: Materials in Electronics, vol. 26, no. 8, pp. 6319-6328, 2015/08/01 2015.
[88] P. Shi et al., “Simultaneously Exfoliated Boron-Doped Graphene Sheets To Encapsulate Sulfur for Applications in Lithium-Sulfur Batteries,” ACS Sustainable Chemistry & Engineering, vol. 6, no. 8, pp. 9661-9670, 2018/08/06 2018.
[89] A. Ejigu, B. Miller, I. A. Kinloch, and R. A. W. Dryfe, “Optimisation of electrolytic solvents for simultaneous electrochemical exfoliation and functionalisation of graphene with metal nanostructures,” Carbon, vol. 128, pp. 257-266, 2018/03/01/2018.
[90] W. Wu, C. Zhang, and S. Hou, “Electrochemical exfoliation of graphene and graphene-analogous 2D nanosheets,” Journal of Materials Science, vol. 52, no. 18, pp. 10649-10660, 2017/09/01 2017.
[91] Y. Fang et al., “Janus electrochemical exfoliation of two-dimensional materials,” Journal of Materials Chemistry A, vol. 7, no. 45, pp. 25691-25711, 2019.
[92] Y. Zhang and Y. Xu, “Simultaneous Electrochemical Dual-Electrode Exfoliation of Graphite toward Scalable Production of High-Quality Graphene,” Adv. Funct. Mater., vol. 29, no. 37, p. 1902171, 2019/09/01 2019.
[93] M. H. Dalal, C.-Y. Lee, and G. G. Wallace, “Simultaneous Anodic and Cathodic Exfoliation of Graphite Electrodes in an Aqueous Solution of Inorganic Salt,” ChemElectroChem, vol. 8, no. 16, pp. 3168-3173, 2021/08/13 2021.
[94] G. Wang, B. Wang, J. Park, Y. Wang, B. Sun, and J. Yao, “Highly efficient and large-scale synthesis of graphene by electrolytic exfoliation,” Carbon, vol. 47, no. 14, pp. 3242-3246, 2009/11/01/2009.
[95] C.-Y. Su, A.-Y. Lu, Y. Xu, F.-R. Chen, A. N. Khlobystov, and L.-J. Li, “High-Quality Thin Graphene Films from Fast Electrochemical Exfoliation,” ACS Nano, vol. 5, no. 3, pp. 2332-2339, 2011/03/22 2011.
[96] F. Kang, Y. Leng, and T.-Y. Zhang, “Influences of H₂O₂ on synthesis of H2SO4-GICs,” Journal of Physics and Chemistry of Solids, vol. 57, no. 6, pp. 889-892, 1996/06/01/1996.
[97] K. Parvez et al., “Exfoliation of Graphite into Graphene in Aqueous Solutions of Inorganic Salts,” Journal of the American Chemical Society, vol. 136, no. 16, pp. 6083-6091, 2014/04/23 2014.
[98] J. R. Dahn, R. Fong, and M. J. Spoon, “Suppression of staging in lithium-intercalated carbon by disorder in the host,” Physical Review B, vol. 42, no. 10, pp. 6424-6432, 10/01/1990.
[99] Z. Zeng et al., “Single-Layer Semiconducting Nanosheets: High-Yield Preparation and Device Fabrication,” Angewandte Chemie International Edition, vol. 50, no. 47, pp. 11093-11097, 2011/11/18 2011.
[100] W. Zhang, L. Sun, J. M. V. Nsanzimana, and X. Wang, “Lithiation/Delithiation Synthesis of Few Layer Silicene Nanosheets for Rechargeable Li—O2 Batteries,” Advanced Materials, vol. 30, no. 15, p. 1705523, 2018/04/01 2018.
[101] Y. L. Zhong and T. M. Swager, “Enhanced Electrochemical Expansion of Graphite for in Situ Electrochemical Functionalization,” Journal of the American Chemical Society, vol. 134, no. 43, pp. 17896-17899, 2012/10/31 2012.
[102] Y. Yang et al., “Electrochemically triggered graphene sheets through cathodic exfoliation for lithium ion batteries anodes,” RSC Advances, vol. 3, no. 36, pp. 16130-16135, 2013.
[103] J. M. Tarascon and M. Armand, “Issues and challenges facing rechargeable lithium batteries,” Nature, vol. 414, no. 6861, pp. 359-367, 2001/11/01 2001.
[104] X.-B. Cheng, R. Zhang, C.-Z. Zhao, and Q. Zhang, “Toward Safe Lithium Metal Anode in Rechargeable Batteries: A Review,” Chemical Reviews, vol. 117, no. 15, pp. 10403-10473, 2017/08/09 2017.
[105] B. Liu, J.-G. Zhang, and W. Xu, “Advancing Lithium Metal Batteries,” Joule, vol. 2, no. 5, pp. 833-845, 2018/05/16/2018.
[106] Y. Lu, Z. Tu, and L. A. Archer, “Stable lithium electrodeposition in liquid and nanoporous solid electrolytes,” Nature Materials, vol. 13, no. 10, pp. 961-969, 2014/10/01 2014.
[107] R. Cao, W. Xu, D. Lv, J. Xiao, and J.-G. Zhang, “Anodes for Rechargeable Lithium-Sulfur Batteries,” Advanced Energy Materials, vol. 5, no. 16, p. 1402273, 2015/08/01 2015.
[108] S.-H. Wang et al., “Stable Li Metal Anodes via Regulating Lithium Plating/Stripping in Vertically Aligned Microchannels,” Advanced Materials, vol. 29, no. 40, p. 1703729, 2017/10/01 2017.
[109] D. Lin et al., “Layered reduced graphene oxide with nanoscale interlayer gaps as a stable host for lithium metal anodes,” Nature Nanotechnology, vol. 11, no. 7, pp. 626-632, 2016/07/01 2016.
[110] R. Zhang et al., “Lithiophilic Sites in Doped Graphene Guide Uniform Lithium Nucleation for Dendrite-Free Lithium Metal Anodes,” Angewandte Chemie International Edition, vol. 56, no. 27, pp. 7764-7768, 2017/06/26 2017.
[111] H. Liu et al., “Unique 3D nanoporous/macroporous structure Cu current collector for dendrite-free lithium deposition,” Energy Storage Materials, vol. 17, pp. 253-259, 2019/02/01/2019.
[112] V.-C. Ho et al., “Effect of an organic additive in the electrolyte on suppressing the growth of Li dendrites in Li metal-based batteries,” Electrochimica Acta, vol. 279, pp. 213-223, 2018/07/20/2018.
[113] N.-W. Li, Y.-X. Yin, C.-P. Yang, and Y.-G. Guo, “An Artificial Solid Electrolyte Interphase Layer for Stable Lithium Metal Anodes,” Advanced Materials, vol. 28, no. 9, pp. 1853-1858, 2016/03/012016.
[114] X. Zhang et al., “Self-Suppression of Lithium Dendrite in All-Solid-State Lithium Metal Batteries with Poly(vinylidene difluoride)-Based Solid Electrolytes,” Advanced Materials, vol. 31, no. 11, p. 1806082, 2019/03/01 2019.
[115] Z. Li et al., “Single ion conducting lithium sulfur polymer batteries with improved safety and stability,” Journal of Materials Chemistry A, vol. 6, no. 29, pp. 14330-14338, 2018.
[116] A. M. Abdelkader, I. A. Kinloch, and R. A. Dryfe, “Continuous electrochemical exfoliation of micrometer-sized graphene using synergistic ion intercalations and organic solvents,” ACS Appl Mater Interfaces, vol. 6, no. 3, pp. 1632-9, Feb. 12 2014.
[117] Y. Setsuhara, K. Cho, M. Shiratani, M. Sekine, and M. Hori, “X-Ray photoelectron spectroscopy analysis of plasma-polymer interactions for development of low-damage plasma processing of soft materials,” Thin Solid Films, vol. 518, no. 22, pp. 6492-6495, 2010/09/01/2010.
[118] S. W. Lee, B.-S. Kim, S. Chen, Y. Shao-Horn, and P. T. Hammond, “Layer-by-Layer Assembly of All Carbon Nanotube Ultrathin Films for Electrochemical Applications,” Journal of the American Chemical Society, vol. 131, no. 2, pp. 671-679, 2009/01/21 2009.
[119] B. Cord, J. Yang, H. Duan, D. C. Joy, J. Klingfus, and K. K. Berggren, “Limiting factors in sub-10 nm scanning-electron-beam lithography,” Journal of Vacuum Science & Technology B: Microelectronics and Nanometer Structures Processing, Measurement, and Phenomena, vol. 27, no. 6, pp. 2616-2621, 2009/11/01 2009.
[120] B. Schnyder, D. Alliata, R. Kötz, and H. Siegenthaler, “Electrochemical intercalation of perchlorate ions in HOPG: an SFM/LFM and XPS study,” Applied Surface Science, vol. 173, no. 3, pp. 221-232, 2001/03/29/2001.
[121] Y. Yi et al., “Electrochemical corrosion of a glassy carbon electrode,” Catalysis Today, vol. 295, pp. 32-40, 2017/10/15/2017.
[122] R. P. Vidano, D. B. Fischbach, L. J. Willis, and T. M. Loehr, “Observation of Raman band shifting with excitation wavelength for carbons and graphites,” Solid State Communications, vol. 39, no. 2, pp. 341-344, 1981/07/01/1981.
[123] J.-B. Wu, M.-L. Lin, X. Cong, H.-N. Liu, and P.-H. Tan, “Raman spectroscopy of graphene-based materials and its applications in related devices,” Chemical Society Reviews, vol. 47, no. 5, pp. 1822-1873, 2018.
[124] A. C. Ferrari, “Raman spectroscopy of graphene and graphite: Disorder, electron-phonon coupling, doping and nonadiabatic effects,” Solid State Communications, vol. 143, no. 1, pp. 47-57, 2007/07/01/2007.
[125] R. Vidano and D. B. Fischbach, “New Lines in the Raman Spectra of Carbons and Graphite,” Journal of the American Ceramic Society, vol. 61, no. 1-2, pp. 13-17, 1978/01/011978.
[126] B. Krauss, T. Lohmann, D. H. Chae, M. Haluska, K. von Klitzing, and J. H. Smet, “Laser-induced disassembly of a graphene single crystal into a nanocrystalline network,” Physical Review B, vol. 79, no. 16, p. 165428, 04/22/2009.
[127] F. Zhao et al., “Chemoselective Photodeoxidization of Graphene Oxide Using Sterically Hindered Amines as Catalyst: Synthesis and Applications,” ACS Nano, vol. 6, no. 4, pp. 3027-3033, 2012/04/24 2012.
[128] T. L. Broder, D. S. Silvester, L. Aldous, C. Hardacre, A. Crossley, and R. G. Compton, “The electrochemical oxidation and reduction of nitrate ions in the room temperature ionic liquid [C2mim][NTf2]; the latter behaves as a ‘melt’ rather than an ‘organic solvent’,” New Journal of Chemistry, vol. 31, no. 6, pp. 966-972, 2007.
[129] B. J. Finlayson-Pitts, L. M. Wingen, A. L. Sumner, D. Syomin, and K. A. Ramazan, “The heterogeneous hydrolysis of NO2 in laboratory systems and in outdoor and indoor atmospheres: An integrated mechanism,” Physical Chemistry Chemical Physics, vol. 5, no. 2, pp. 223-242, 2003.
[130] F. Beck, H. Junge, and H. Krohn, “Graphite intercalation compounds as positive electrodes in galvanic cells,” Electrochimica Acta, vol. 26, no. 7, pp. 799-809, 1981/07/01/1981.
[131] J. D. Bernal and W. L. Bragg, “The structure of graphite,” Proceedings of the Royal Society of London. Series A, Containing Papers of a Mathematical and Physical Character, vol. 106, no. 740, pp. 749-773, 1924/12/011924.
[132] D. D. L. Chung, “Review Graphite,” Journal of Materials Science, vol. 37, no. 8, pp. 1475-1489, 2002/04/012002.
[133] Y. Liu, B. V. Merinov, and W. A. Goddard, “Origin of low sodium capacity in graphite and generally weak substrate binding of Na and Mg among alkali and alkaline earth metals,” Proceedings of the National Academy of Sciences, vol. 113, no. 14, pp. 3735-3739, 2016/04/05 2016.
[134] G. Kresse and J. Hafner, “Ab initio molecular dynamics for liquid metals,” Physical Review B, vol. 47, no. 1, pp. 558-561, 01/01/1993.
[135] G. Kresse and J. Furthmüller, “Efficient iterative schemes for ab initio total-energy calculations using a plane-wave basis set,” Physical Review B, vol. 54, no. 16, pp. 11169-11186, 10/15/1996.
[136] J. P. Perdew, K. Burke, and M. Ernzerhof, “Generalized Gradient Approximation Made Simple,” Physical Review Letters, vol. 77, no. 18, pp. 3865-3868, 10/28/1996.
[137] S. Grimme, J. Antony, S. Ehrlich, and H. Krieg, “A consistent and accurate ab initio parametrization of density functional dispersion correction (DFT-D) for the 94 elements H—Pu,” The Journal of Chemical Physics, vol. 132, no. 15, p. 154104, 2010.
[138] H. J. Monkhorst and J. D. Pack, “Special points for Brillouin-zone integrations,” Physical Review B, vol. 13, no. 12, pp. 5188-5192, 06/15/1976.
[139] A. Shellikeri et al., “Investigation of Pre-lithiation in Graphite and Hard-Carbon Anodes Using Different Lithium Source Structures,” Journal of The Electrochemical Society, vol. 164, no. 14, p. A3914, 2017/12/28 2017.
[140] Y. Yamada, Y. Takazawa, K. Miyazaki, and T. Abe, “Electrochemical Lithium Intercalation into Graphite in Dimethyl Sulfoxide-Based Electrolytes: Effect of Solvation Structure of Lithium Ion,” The Journal of Physical Chemistry C, vol. 114, no. 26, pp. 11680-11685, 2010/07/08 2010.
[141] Y. L. Frolov, I. V. Guchik, V. A. Shagun, A. V. Vaschenko, and B. A. Trofimov, “Quantum Chemical Study of the Lithium Cation Coordination by Dimethylsulfoxide Molecules,” Journal of Structural Chemistry, vol. 44, no. 6, pp. 927-931, 2003/11/01 2003.
[142] A. C. Ferrari et al., “Raman Spectrum of Graphene and Graphene Layers,” Physical Review Letters, vol. 97, no. 18, p. 187401, 10/30/2006.
[143] Q. Liu et al., “Insight on lithium metal anode interphasial chemistry: Reduction mechanism of cyclic ether solvent and SEI film formation,” Energy Storage Materials, vol. 17, pp. 366-373, 2019/02/01/2019.
[144] X. Yu and A. Manthiram, “Electrode-electrolyte interfaces in lithium-based batteries,” Energy & Environmental Science, 10.1039/C7EE02555F vol. 11, no. 3, pp. 527-543, 2018.
[145] D. Aurbach, Y. Ein-Ely, and A. Zaban, “The Surface Chemistry of Lithium Electrodes in Alkyl Carbonate Solutions,” Journal of The Electrochemical Society, vol. 141, no. 1, p. L1, 1994/01/011994.
[146] D. Aurbach and Y. Cohen, “Morphological Studies of Li Deposition Processes in LiAsF6/PC Solutions by In Situ Atomic Force Microscopy,” Journal of The Electrochemical Society, vol. 144, no. 10, p. 3355, 1997/10/011997.
[147] D. Aurbach, M. L. Daroux, P. W. Faguy, and E. Yeager, “Identification of Surface Films Formed on Lithium in Dimethoxyethane and Tetrahydrofuran Solutions,” Journal of The Electrochemical Society, vol. 135, no. 8, p. 1863, 1988/08/011988.
[148] X. R. Z. X.-Q. Cheng, “X.-B. Peng H.-J. Zhao C.-Z. Yan C. Huang J.-Q,” Adv. Funct. Mater, vol. 28, p. 1705838, 2018.
[149] R. Chen, Q. Li, X. Yu, L. Chen, and H. Li, “Approaching Practically Accessible Solid-State Batteries: Stability Issues Related to Solid Electrolytes and Interfaces,” Chemical Reviews, vol. 120, no. 14, pp. 6820-6877, 2020/07/22 2020.
[150] T. Li, X.-Q. Zhang, P. Shi, and Q. Zhang, “Fluorinated Solid-Electrolyte Interphase in High-Voltage Lithium Metal Batteries,” Joule, vol. 3, no. 11, pp. 2647-2661, 2019/11/20/2019.
[151] J. He, A. Bhargav, and A. Manthiram, “Covalent Organic Framework as an Efficient Protection Layer for a Stable Lithium-Metal Anode,” Angewandte Chemie International Edition, vol. 61, no. 18, p. e202116586, 2022/04/25 2022.
[152] M. Matsumoto et al., “Lewis-Acid-Catalyzed Interfacial Polymerization of Covalent Organic Framework Films,” Chem, vol. 4, no. 2, pp. 308-317, 2018/02/08/2018.
[153] B. J. Smith, A. C. Overholts, N. Hwang, and W. R. Dichtel, “Insight into the crystallization of amorphous imine-linked polymer networks to 2D covalent organic frameworks,” Chemical Communications, vol. 52, no. 18, pp. 3690-3693, 2016.
[154] L. He et al., “Electrochemical exfoliation and functionalization of black phosphorene to enhance mechanical properties and flame retardancy of waterborne polyurethane,” Composites Part B: Engineering, vol. 202, p. 108446, 2020/12/01/2020.
[155] L. Mei et al., “Simultaneous Electrochemical Exfoliation and Covalent Functionalization of MoS2 Membrane for Ion Sieving,” Advanced Materials, p. 2201416, 2022/07/012022.

The references cited herein are hereby incorporated by reference to disclose and describe the methods or materials in connection with which the publications are cited or to provide background for the present disclosure. Any incorporation by reference of documents herein is limited such that no subject matter is incorporated by reference that is contrary to the explicit disclosure herein. In the event of inconsistent usages between this document and those documents so incorporated by reference herein, the use in the incorporated references should be considered supplementary to that of this document; for irreconcilable inconsistencies, the usage in this document controls.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

What is claimed is:

1. A method of producing isolated graphene sheets from graphite,
wherein the graphite contains therein hexagonal carbon atomic interlayers with an interlayer spacing,
the method comprising:
(a) forming an intercalated graphite compound by an electrochemical intercalation procedure conducted in an electrochemical reactor,
wherein the reactor comprises:
(i) a solution comprising an intercalating electrolyte, a first solvent, and a second solvent;
(ii) a working electrode comprising the graphite in contact with the solution; and
(iii) a counter electrode in contact with the solution;
wherein a current is imposed to effect electrochemical intercalation of the intercalating electrolyte into the interlayer spacing; and
(b) exfoliating and separating the hexagonal carbon atomic interlayers from the intercalated graphite compound to produce the isolated graphene sheets.

2. The method of claim 1, wherein the isolated graphene sheets comprise single-layer graphene sheets.

3. The method of claim 1, wherein the isolated graphene sheets comprise few-layer graphene sheets comprising from about 2 to about 10 layers.

4. The method of claim 1, wherein the first solvent and the second solvent are present in a ratio of about 1:2 of the first solvent to the second solvent.

5. The method of claim 1, wherein the first solvent comprises dimethyl sulfoxide (DMSO).

6. The method of claim 1, wherein the intercalating electrolyte comprises a lithium ion.

7. The method of claim 6, wherein the lithium ion forms a complex with DMSO, and said complex intercalates into the interlayer spacing.

8. The method of claim 6, wherein the intercalating electrolyte comprises lithium perchlorate.

9. The method of claim 1, wherein the second solvent comprises dimethyl carbonate (DMC).

10. The method of claim 1, wherein the first solvent and the second solvent can reduce a solvation number of the intercalating electrolyte compared to a solvation number of the intercalating electrolyte in the first solvent or the second solvent alone.

11. A plurality of graphene sheets produced by a method of claim 1.

12. An article or device comprising a plurality of graphene sheets of claim 11.

13. The article or device of claim 12, wherein the device comprises an electrode, an electrochemical cell, or a battery.

14. The article or device of claim 13, wherein the device comprises a lithium ion battery.

15. An electrochemical intercalation reactor comprising:
(i) a solution comprising an intercalating electrolyte, a first solvent, and a second solvent;
(ii) a working electrode comprising graphite in contact with the solution; and
(iii) a counter electrode in contact with the solution.

16. The electrochemical intercalation reactor of claim 15, wherein the intercalating electrolyte comprises a lithium ion.

17. The electrochemical intercalation reactor of claim 15, wherein the intercalating electrolyte comprises lithium perchlorate.

18. The electrochemical intercalation reactor of claim 15, wherein the first solvent comprises dimethyl sulfoxide (DMSO).

19. The electrochemical intercalation reactor of claim 15, wherein the second solvent comprises dimethyl carbonate (DMC).

20. The electrochemical intercalation reactor of claim 15, wherein the graphite comprises a foil, a rod, a powder, or a sheet.
